(19) United States
(12) Patent Application Publication
(10) Pub. No.: US 2023/0061969 A1
(43) Pub. Date: Mar. 2, 2023

(54) ADVISOR INTERFACE SYSTEMS AND METHODS

(71) Applicant: DEAL.COM INC., San Francisco, CA (US)

(72) Inventors: Alex Vauthey, San Francisco, CA (US); Annabel Liu, Los Altos, CA (US); Iain MacNaughton, San Francisco, CA (US); Eduardo Vivas, San Francisco, CA (US); Joseph Florencio, San Jose, CA (US); Kyle Johnson, Sausalito, CA (US); Kyle Sosnowski, Menlo Park, CA (US); Peter Ombres, San Francisco, CA (US); Qi Liu, Saratoga, CA (US); Rodrigo Parras, Cascavel (BR)

(21) Appl. No.: 17/976,609

(22) Filed: Oct. 28, 2022

Related U.S. Application Data
(62) Division of application No. 17/085,535, filed on Oct. 30, 2020.
(60) Provisional application No. 62/928,340, filed on Oct. 30, 2019.
(60) Provisional application No. 63/022,120, filed on May 8, 2020.

(51) Int. Cl. G06Q 30/06; G06Q 30/02; G06Q 20/40

(52) U.S. Cl. CPC G06Q 30/0631; G06Q 30/0281; G06Q 30/0617; G06Q 20/4016

(57) ABSTRACT

Systems and methods managing interaction between one of a plurality of advisors and a client. Client intent is determined based upon request details indicating a category of interest to the client. One of a plurality of advisors is selected to advise the client based, at least in part, upon the category and the client intent. The client is added to a sales pipeline of the selected advisor, and the selected advisor is prompted, at intervals, to interact with the client. The workload of each advisor is managed. The selected advisor is also prompted to generate and send a curation to the client. The systems and methods also provides e-commerce card fraud protection using conventional transaction processing methodology by including a random code in a pending transaction for the card and finalizing the transaction with the card provider when the code is correctly returned by the client.

### RELATED APPLICATIONS

This application is a divisional of U.S. patent application Ser. No. 17/085,535, titled “Advisor INTERFACE Systems and Methods,” filed Oct. 30, 2020, which claims priority to U.S. Provisional Application No. 62/928,340, filed Oct. 30, 2019, and to U.S. Provisional Application No. 63/022,120, filed May 8, 2020, each of which is incorporated herein by reference in its entirety.

### SUMMARY

High consideration purchases do not work with today's e-commerce platforms. E-commerce has been solely focused on automation and cost reduction. High consideration purchases require a live conversation with an advisor (not a high-pressure salesman), establishing trust in the consumer by providing personal recommendations to the consumer.

One advisor may help multiple clients simultaneously and receive commission based compensation. Advisor ranking allows more business to be given to better advisors and advisors are matched to a client's need. Though better matching, direct communication, personalized advice, and a custom curation, clients feel a personal connection which results in a high conversion rate and repeat business. The custom curation is a personalized recommendation of at least one product based upon a category of interest, determined client intent, and a conversation between the client and an advisor. Advantageously, clients have a higher confidence that they are purchasing the right item since with advice the client purchases the right product the first time, which results in a higher client satisfaction and a lower product return rate, as compared to conventional ecommerce sites. Clients may share their advisors with their network (referrals/network effect) resulting in additional leads.

In one embodiment, a method manages interaction between one advisor of a plurality of advisors and a client. Client intent is determined based upon request details that indicate a category of interest to the client. The one advisor is selected from the plurality of advisors to advise the client based, at least in part, upon the category of interest and the client intent. The client is added to a sales pipeline of the one advisor, and the one advisor is prompted, at intervals, to interact with the client. The one advisor is prompted to generate a curation for the client, and the curation is sent to the client.

In another embodiment, a path module includes a path builder having machine readable instructions stored in memory that, when executed by at least one processor, cause the processor to implement an interface for creating and editing sets of question types and answer types to form a path schema. The path module also includes a selection algorithm having machine readable instructions stored in the memory that, when executed by the processor, cause the at least one processor to generate a path flow based, at least in part, upon the path schema, the path flow comprising at least one web page with a set of questions for receiving request details from a client. The request details include at least one answer to one or more of the set of questions.

In another embodiment, a client trust interface method has optimized workflow and includes specifying a spend on leads to identify a plurality of clients; capturing intent of one client of the plurality of clients; matching one advisor of a plurality of advisors to the one client; triggering actions of the one advisor to correspond with the one client; and generating a curation based at least in part upon request details of the one client.

In another embodiment, a client trust interface system includes a workload optimizer for determining a current workload of each of a plurality of advisors and for determining a workload capacity of each of the plurality of advisors. The workload optimizer defines a spend for generating new leads based upon the current workload and the workload capacity of each of the plurality of advisors. The client trust interface system also includes a client interface for interacting with each of a plurality of clients to determine intent of each of the plurality of clients, and an advisor matcher for matching one advisor of the plurality of advisors with one client of the plurality of clients based upon the intent of the one client and a capability of the one advisor. The client trust interface system also includes a trigger algorithm for prompting a next action for the one advisor based upon a history of actions by the one advisor and responses by the one client, and a communication channel controller (path) for switching between communication channels to maintain communication between the one client and the one advisor.

In another embodiment, an e-commerce method for card fraud protection includes: determining, at an e-commerce site, a value to be charged to a card of a client; generating a random code; including the random code in a transaction for the card; sending the transaction to a card provider corresponding to the card, wherein the transaction is posted as pending in a transaction list of an account corresponding to the card; receiving, from the client, a code value determined from display of the transaction; and finalizing the transaction with the card provider for the value to be charged when the code value matches the random code.

### BRIEF DESCRIPTION OF THE FIGURES

FIG. 1 is a schematic diagram illustrating a high-level view of an advisor interface system, in embodiments.

FIG. 2 shows the system of FIG. 1 in further example detail illustrating communication between modules, in embodiments.

FIG. 3 is a functional diagram illustrating example operation of the path module of FIG. 2, in embodiments.

FIG. 4 is a functional diagram illustrating example operation of the workload optimizer of FIG. 2, in embodiments.

FIG. 5 is a functional diagram illustrating example operation of the trigger module of FIG. 2, in embodiments.

FIG. 6 is a functional diagram illustrating example operation of the sales pipeline of FIG. 2, in embodiments.

FIG. 7 is a block diagram illustrating the advisor dashboard of FIG. 6 in further example detail, in embodiments.

FIG. 8 is a flowchart illustrating one example method for managing interaction between one of a plurality of advisors and a client, in embodiments.

FIG. 9 shows example request details provided in response to an interactive path flow, in embodiments.

FIGS. 10 and 11 show an example conversation between one client and two advisors, in embodiments.

FIG. 12 shows part of the advisor dashboard of FIG. 6 with an example curation generated from a curation template, in an embodiment.

FIG. 13 shows one example screenshot for customizing automatic messages within the system of FIG. 1, in embodiments.

FIG. 14 shows one example dialog window, opened in response to an advisor selecting the customize button, displaying a list of customized automatic first messages, in embodiments.

FIG. 15 shows one example tag quick reply dialog window, which opens when the advisor selects the select button of the dialog window to define context for the corresponding message template, in embodiments.

FIG. 16 shows one example tag quick reply dialog window where the advisor has selected a “set as default” check-box to indicate that the template should be used as the default message for a particular category, in embodiments.

FIG. 17 shows one example dialog showing a list of saved messages templates under a quick replies tab, and a badged tagged quick replies tab indicating that the saved message template has a defined context for automatic use, in embodiments.

FIG. 18 shows one example dashboard where selection of an “auto curations” tab displays a list of auto curations for unresponsive leads, in embodiments.

FIG. 19 shows one example dialog window that is displayed when the advisor selects a customize button of the list of FIG. 18, in embodiments.

FIG. 20 shows one example tag curation dialog window that allows the advisor to name the curation template and define an experience context for the curation template, in embodiments.

FIG. 21 shows one example tag curation dialog window, displayed for a curation template that is already saved, allowing the advisor to define an experience context, in embodiments.

FIG. 22 shows one example curation template display for a previously saved curation template, showing the context that is matched to clients for automatic use of the saved curation, in embodiments.

FIG. 23 show one example dashboard showing an auto curation that may be sent to clients that are unresponsive and have a client intent and/or path flow that indicate an interest in intermediate all mountain skis, in embodiments.

FIG. 24 shows advisor interface system of FIG. 1 with a processor communicatively coupled with a memory that includes behavior analyzer software and a multivariate linear regression (MVLR) model, in embodiments.

FIG. 25 shows one example performance review that may be generated at intervals and sent to the advisor, in embodiments.

FIG. 26 is an example scatter plot 2600 showing how well the MVLR model of FIG. 24 fits performance for each advisor, in embodiments.

FIG. 27 shows one example leaderboard, generated at intervals by the system of FIG. 1, showing an ordered list of the top ten performing advisors over the last sixty days, in embodiments.

FIGS. 28A and 28B are schematics illustrating dynamic statement descriptor fraud prevention, in an embodiment.

FIG. 29 shows a table with example data used to balance workload of the system of FIG. 1, in embodiments.

FIG. 30 is a table illustrating example seven-day trend data used as input to the calculations of the table of FIG. 29, in embodiments.

FIG. 31 is a schematic illustrating example lead—advisor matching and assignment within the system of FIG. 1, in embodiments.

FIG. 32 is a flowchart illustrating one example greedy assignment algorithm for lead advisor assignment, in embodiments.

FIG. 33 shows one example abandoned cart trigger sequence that branches twice, accounting for three potential outcomes, to send different messaging to a client, in embodiments.

### DETAILED DESCRIPTION OF THE EMBODIMENTS

Systems and methods disclosed herein describe an advance in e-commerce sites and include a computer based platform where independent advisors may enroll with the system to communicate with clients through multiple online channels, and provide advice, make tailored product and service recommendations (curations), and sell products to the clients. The advisor may earn a commission and gratuity on sold products. However, by providing advisors (e.g., experts in specific products and services, sometimes referred to as “experts” herein) that interact with potential clients, product sales are increased multifold as compared to e-commerce sites that do not provides advisors.

One aspect of the present embodiments includes the realization that clients require greater confidence when purchasing products and services above a certain price range. For example, a client is unlikely to purchase a new sailing boat costing $100,000 by simply selecting a ‘buy now” button on a web page advertising the sailing boat. The present embodiments solve this problem by matching the client with an advisor (who may also be known as an expert) on the product, or in a field of the product, and allowing the advisor to create tailored product and service recommendations (a curation) for the client based upon the client's needs. Advantageously, interaction with the advisor and receiving the curation builds client confidence in making the purchase.

Another aspect of the present embodiments includes the realization that lack of trust to make a purchase may result from a client being uncertain as to which product, variant, etc., they should purchase to meet their needs. The present embodiments solve this problem by automatically interacting with the client to determine intent and needs of the client and then automatically selecting an advisor who will best help the client make correct product choices through their experience in the product field. The advisor not only answers the client's questions about the product, but, through awareness of the client's intent, experience, and demographic, may advise the client on selecting the most appropriate product to meet the client's needs. Advantageously, the interaction with the advisor builds client confidence to make the purchase.

Another aspect of the present embodiments includes the realization that an advisor may have conversations with hundreds of clients, each client having different needs, budgets, timescales, etc., and that it is therefore difficult for the advisor to prioritize conversations and keep track of which ones need responses and/or follow-ups. The present embodiments solve this problem by providing the advisor with sales pipeline (e.g., an interactive dashboard) that displays folders for tracking and prioritizing the advisor's conversations, and recommends the best next step to be taken with the client.

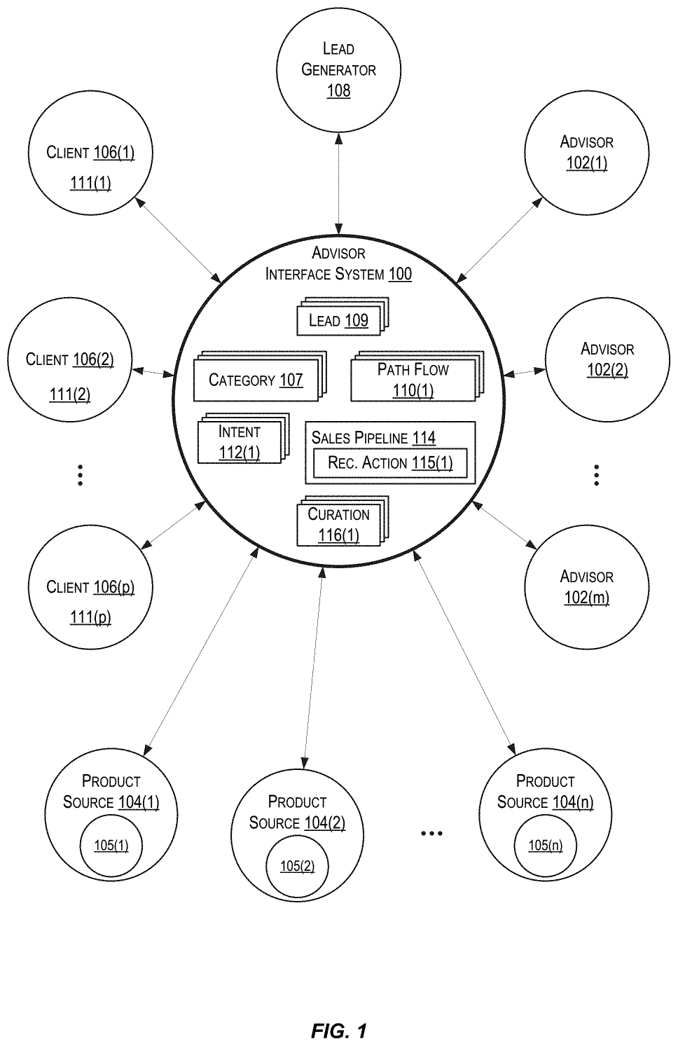

FIG. 1 is a schematic diagram illustrating a high-level view of an advisor interface system 100. System 100 facilitates interaction between a plurality of advisors 102 (illustratively shown as advisors (1)-(m)) and a plurality of clients 106 (illustratively shown as clients 106(1)-(p)). System 100 may also interact with at least one product source 104 (illustratively shown as product sources 104(1)-(n)) that represents one of a manufacturer and/or retailer that has at least one product 105 for sale. Accordingly, system 100 receives information of product 105 from product source 104. Although the term product is used herein, services (e.g., nutrition, travel planning, etc.) are also included. Within system 100, products 105 care categorized on one of a plurality of categories 107 (e.g., golf, winter sports, jewelry, and so on). As used herein, the term category may refer to a product type or category and/or a service type. Different product sources 104 may have products 105 that are similar to one another and that therefore fall under the same category 107. For example, first product source 104(1) may supply a first product 105(1) that is a certain brand of golf clubs, and a second product source 104(2) may supply second product 105(2) that is a golf cart. Both first and second products 105(1) and 105(2) are in the “golf” category 107.

System 100 receives leads 109, identifying a particular client 106 and a product category 107 that the client 106 is interested in, from at least one lead generator 108. Each lead 109 directly corresponds to one client 106 and the term lead and client may be used interchangeably herein. Lead generator 108 is for example a service that provides leads based upon advertising, social media, and so on. Examples of lead generator 108 include Google™ Facebook™, etc.

For each product category 107, system 100 may implement at least one path flow 110 that defines question types, answer types, and an order of questions that may be used to generate a path flow as a series of interactive screens designed to learn, from client 106, information about the client's interest in certain products within that product category. For example, based, at least in part, upon lead 109 that identifies client 106 and indicates an interest in golf, system 100 automatically invites client 106 to interact with path flow 110 corresponding to golf. In other embodiments, where lead 109 does not indicate any categories 107, path flow 110 may be selected to learn (e.g., a screen where client selects one of categories 107) which category 107 client 106 is interested in. System 100 processes the interaction (e.g., responses, selections, comments, timing, etc.) made by client 106 to automatically determine intent 112 of client 106 towards one or more golf products. For example, as client 106 interacts with path flow 110, system 100 may track the amount of time the client spends viewing information of product 105 (e.g., a certain brand and selection of golf clubs), thereby learning intent 112 of client 106 towards product 105. Path flow 110 may also allow system 100 to learn more about client 106, such as a skill level, time investment level, and so on. For example, system 100 may learn whether client 106 is a good golfer (low handicap), intermediate golfer (average handicap), or just beginning to play golf.

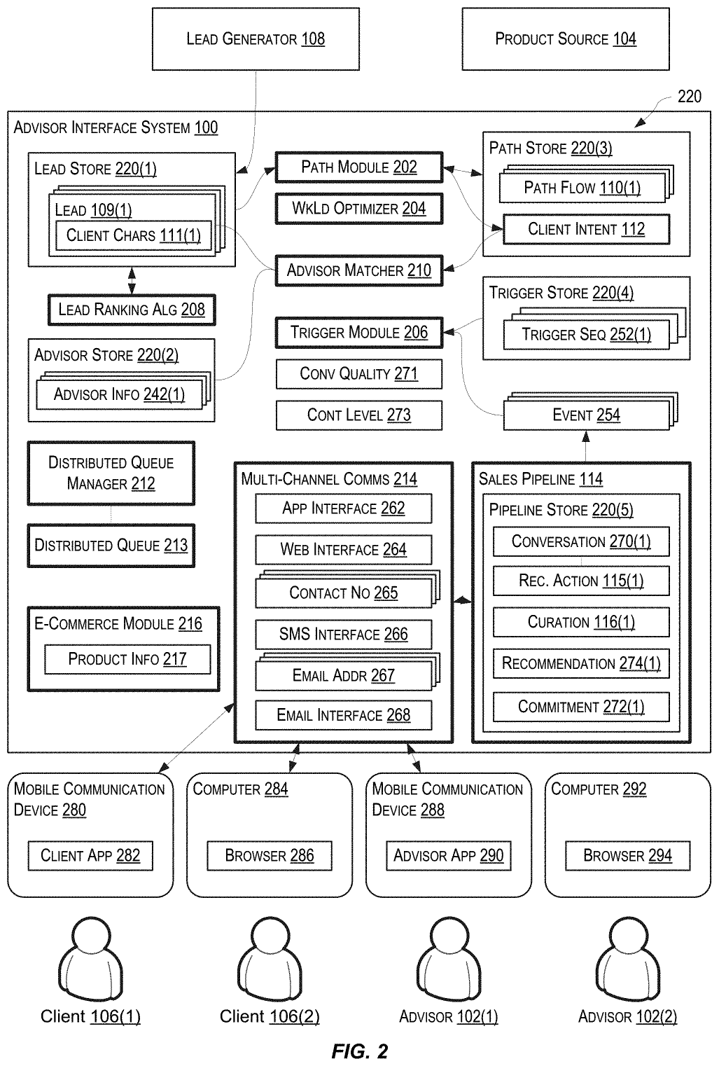

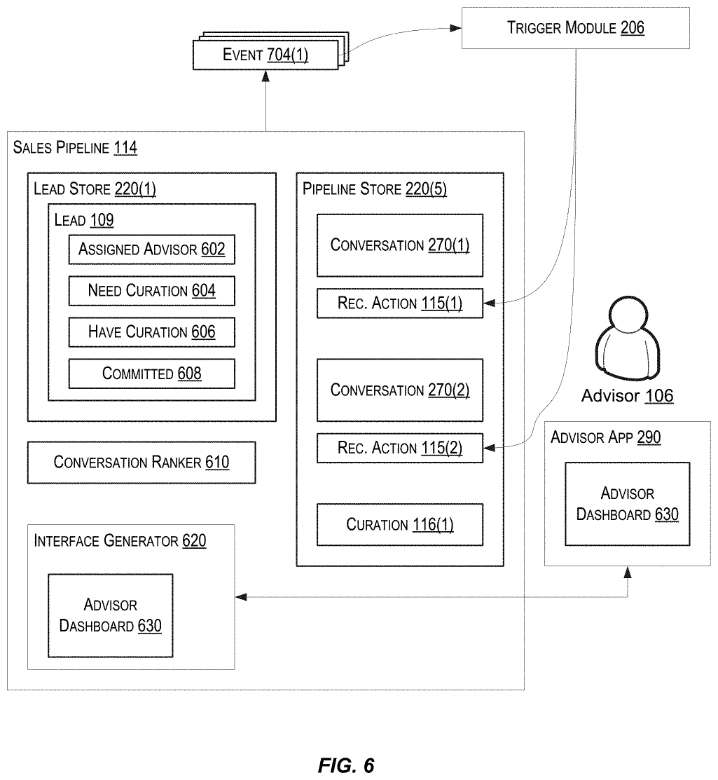

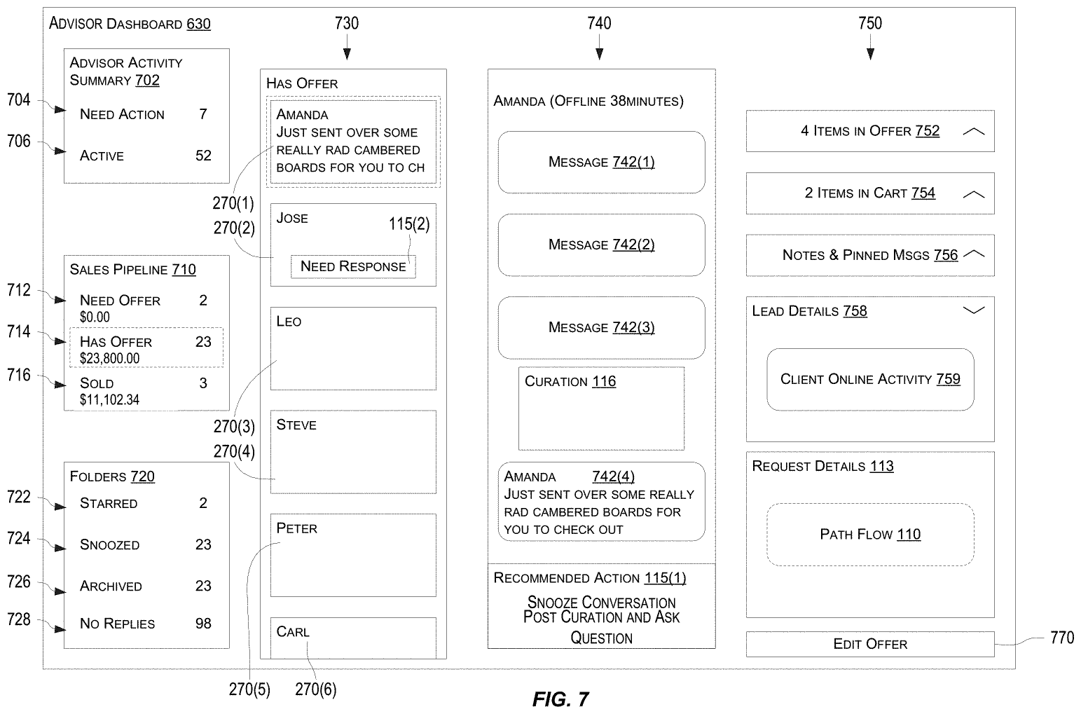

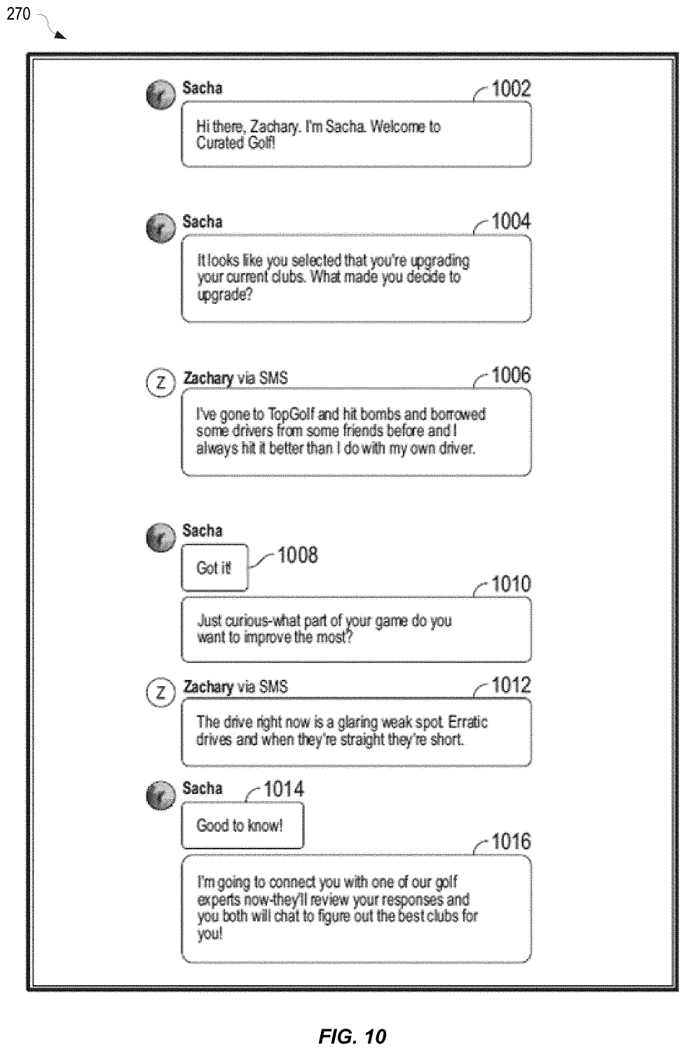

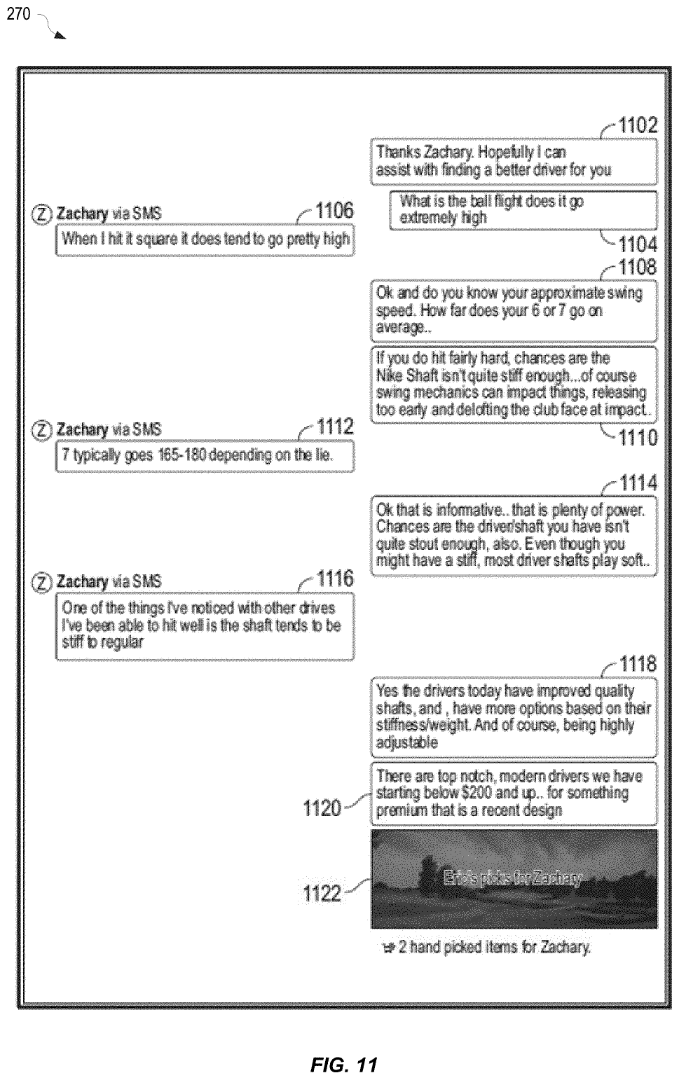

System 100 may then select a most suitable advisor 102 that is available to help advise client 106 on selection of product 105. For example, system 100 selects advisor 102 based upon the indicated product category 107, client characteristics 111, and client intent 112. System 100 provides advisor 102 with a sales pipeline 114 that allows advisor 102 to converse with client 106 and build confidence in the client's understanding and suitability of product 105 for their needs. Sales pipeline 114 is based upon folders that allow advisor 102 to easily track and prioritize conversations (see for example conversation 270, FIG. 2) with multiple clients 106, and may provide one or more recommended actions 115 that prompt advisor 102 during the conversation with client 106. FIGS. 10 and 11 show an example conversation between client 106 and two advisors 102, where a first advisor hands the conversation over to a second advisor. FIG. 10 shows an initial part of conversation 270 where client 106 (Zachary) has completed path flow 110 and an initial advisor 102 (Sacha) has been assigned as a first contact for Zachary. In this example, in message 1002, advisor 102 (Sacha) introduces herself to Zachary and in message 1004, Sacha prompts for additional information to learn further details of Zachary's needs. Sacha and Zachary converse as shown in messages 1006-1014, until Sacha has learned enough about Zachary to handover conversation 270 to another, more appropriate, advisor 102 (Eric). As shown in FIG. 11, Eric continues conversation 270, having seen the full context of Zachary's needs (e.g., in dashboard 630 of FIGS. 6 and 7). Conversation 270 continues with messages 1102-1120 that build purchasing confidence in client 106 (Zachary).

At a certain point in conversation 270 between client 106 and advisor 102, system 100 may generate recommended action 115 to prompt advisor 102 to generate curation 116 tailoring product 105 towards needs of client 106. For example, as shown in FIG. 11, advisor 102 (Eric) generates and sends 1122 curation 116 to client 106 (Zachary). curation 116 may identify and specify customization of product 105 that best meets the needs and interest of client 106. Curation 116 may identify and compare similar products based upon characteristics 111 and intent 112 of client 106, thereby providing knowledge and building confidence in client 106 towards product 105. Advisor 102 may interact with client 106 to answer questions, better understand the needs and intent of client 106 towards purchasing product 105, and may provide advice, share experiences, and adjust curation 116 accordingly. This interaction may use one or more communication channels to allow complete native text exchanges, and communications may include attachments and links. Advantageously, system 100 makes communication familiar and natural for both client 106 and advisor 102 through multi-channel communications 214, described in more detail below.

Advantageously, by matching advisor 102 to needs and intent 112 of client 106, and providing client 106 with a personal curation 116 for product 105, client 106 is at least six times more likely to purchase product 105 as compares to client 106 finding product 105 on a website without conversing with advisor 102.

FIG. 2 shows system 100 of FIG. 1 in further example detail and illustrating example communication between modules. System 100 is implemented using one or more servers that each have at least one processor and memory storing machine readable instructions (e.g., software) that implement functionality of system 100 described herein. In certain embodiments, system 100 is a cloud based service that allows access by advisors 102, product sources 104, clients 106, and lead generators 108, via the Internet and/or other similar networks.

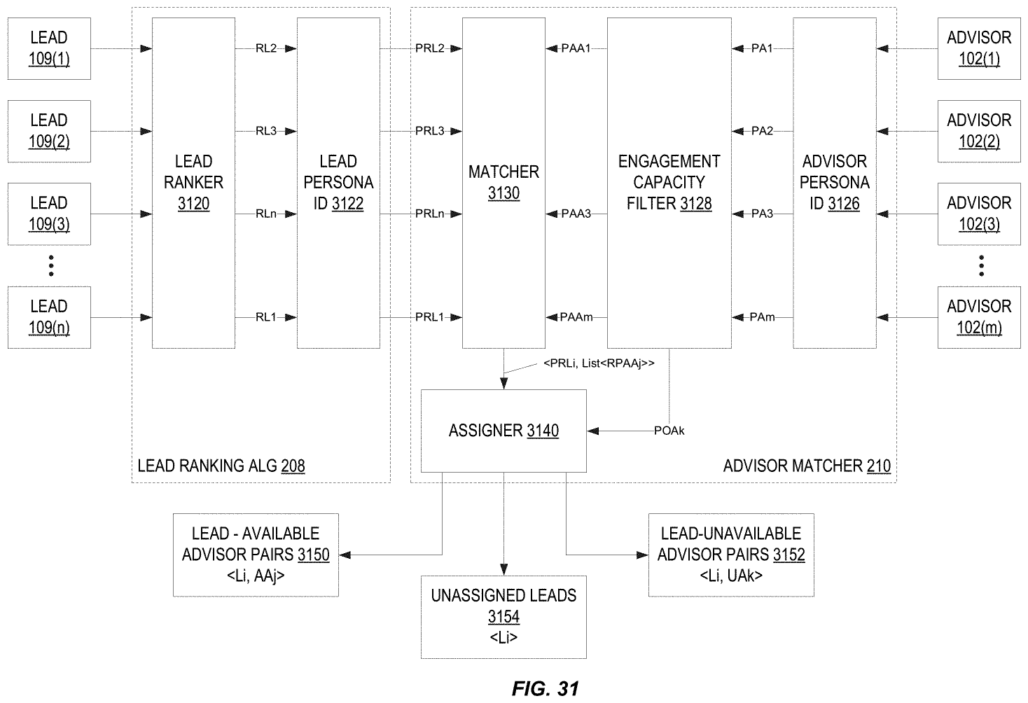

Functionality of system 100 is implemented through cooperation of a plurality of software modules including a path module 202, a workload optimizer 204, a trigger module 206, a lead ranking algorithm 208, an advisor matcher 210 (e.g., an algorithm—see also FIG. 31), a distributed queue manager 212, multi-channel communication 214, and an e-commerce module 216. E-commerce module 216 may be similar to a conventional e-commerce site that allows a user to browse through product information, add items to a shopping cart, and then purchase the items by checking out. E-commerce module 216 may be integrated with system 100.

### Attribute Store

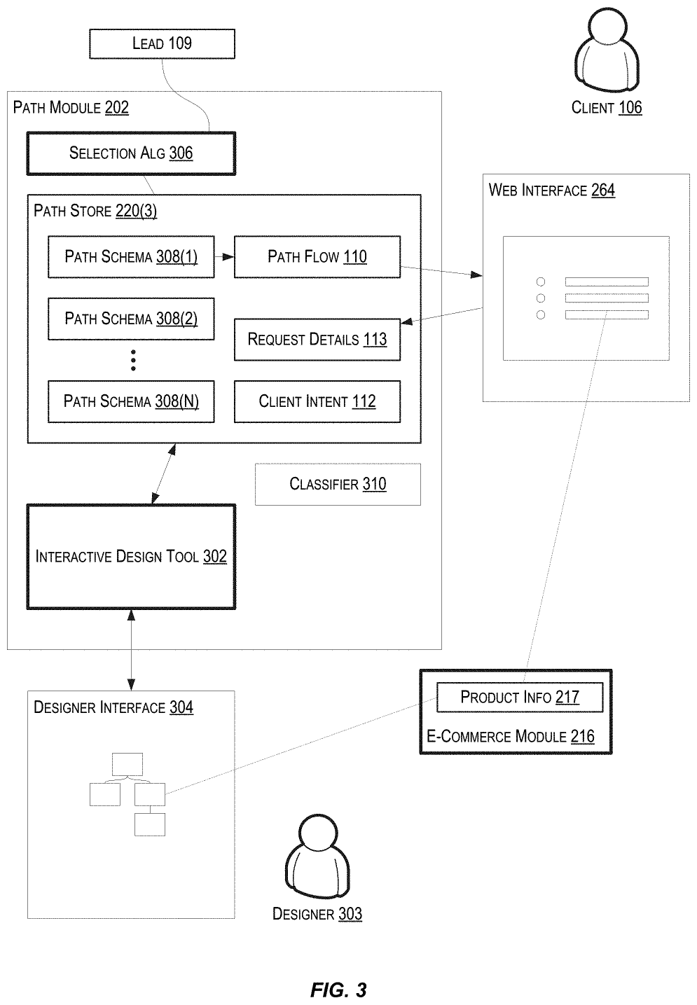

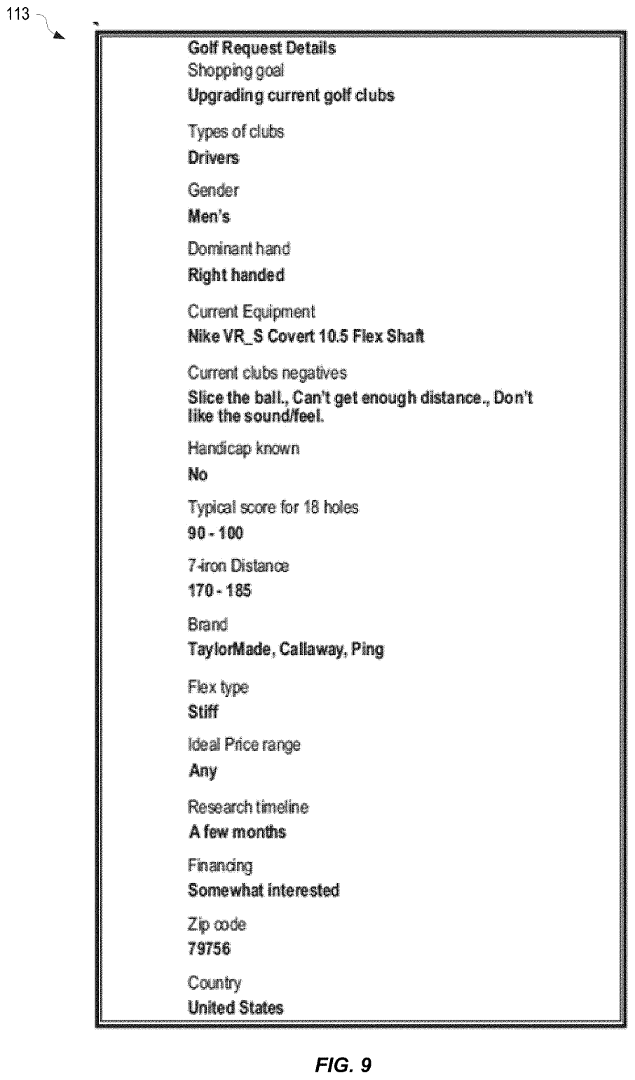

System 100 implements an attribute store 220, shown as lead store 220(1), advisor store 220(2), path store 220(3), and trigger store 220(4), that facilitates core functionality of system 100 by providing advanced data storage and search capabilities specifically tailored to operation of system 100. Attribute store 220 provides flexible, but structured, storage for “sellables” (e.g., products and services), path schemas (e.g., path schema 308, FIG. 3), path flows 110, and request details (e.g., information provided by, or for, a client 106, such as request details 113 of FIG. 3, as shown in the example of FIG. 9, and as displayed on advisor dashboard 630 of FIG. 7). In certain embodiments, attribute storage 220 is, at least in part, stored external to system 100, for example as one or more of network attached storage, remote servers, etc.). To simplify illustration, attribute store 220 is shown in parts, including a lead store 220(1) that stores information of leads 109 received from lead generator 108 and information of associated clients 106, and an advisor store 220(2) that stores advisor information 242 of each advisor 102 using system 100, a path store 220(3) that stores path flows 110 and path schemas 308 (used to generate path flow 110), a trigger store 220(4) that stores at least one trigger sequence 252, and a pipeline store 220(5) that stores information of sales pipeline 114 including conversations 270, recommended actions 115, curations 116, recommendations 274, and commitments 272.

An attribute schema is created to define an attribute (e.g., information types, data, etc.) for storage within attribute store 220 and encodes a range of information such as the attribute name, display name, formatting rules, validation rules, inferred attributes, and many others. Table 1 through Table 12 show example fields and code of an attribute schema for use within the attribute store 220 of FIG. 2, in an embodiment.

Table 1 through Table 3 show example fields of an attribute schema for use within attribute store 220.

TABLE 1
Example Fields of an Attribute Schema

| name | This is the internal name of the schema, which must be globally unique, and | |
|---|---|---|
| | is specified in camel case. Examples are “bikeType”, “ridingExperience”, and | |
| | “charterLengthFeet”. | |
| displayName | This is the name of the attribute that's displayed. | |
| | Search: | When specified as a facet, this is the facet name surfaced to the |
| | | user. For “charterLengthFeet”, the display name is “Length”, |
| | | which is what's shown in search |
| | Path: | Not shown |
| | Request: | The name displayed for the attribute |

| | |
|---|---|
| description | Internal description for the attribute, used as documentation for administrators |
| | when trying to understand this attribute |

TABLE 2
Further Attributes

| type | Data type for the attribute. Note that all attributes are lists of values, so for example an | |
|---|---|---|
| | integer attribute can store zero or more numbers. In addition, there are “Range” variants | |
| | for numeric-like types which represent ranges that are either unbounded or closed on one | |
| | or both sides. For example, [−infinity, +infinity] (i.e. all values), [+5, +infinity] (i.e. | |
| | greater than or equal to 5), [0, +10], . . . | |
| | Integer/IntegerRange | Whole number in the mathematical sense, |
| | | including negative, zero, and positive values. |
| | | Internally this is backed by a signed 64 bit long |
| | | data type, meaning it can store values |
| | | between −2\hat{ }63 to 2\hat{ }63 − 1. |
| | Decimal/DecimalRange | Decimal numbers, including negative, zero, and |
| | | positive values. Internally this is stored with |
| | | exact precision (not approximated like floating |
| | | point). This is useful for things like shoe sizes |
| | | (10.5), measurements, monetary amounts, and |
| | | others. |
| | Text | Free form text value |
| | Enumeration | A pre-defined list of internal names, that are |
| | | each associated with a display name, and |
| | | potentially other metadata. For example, one of |
| | | the enumeration items for the attribute |
| | | “charterLocation” is “HAMPTONS”, with the |
| | | display name “The Hamptons”, and marked as a |
| | | featured facet using the background image of |
| | | “yacht/location/hamptons.jpg”. Later in the |
| | | document will cover more detail about special |
| | | enumeration metadata, but at a base level, there |
| | | is always an internal name and display name. |
| | LocalDate/LocalDateRange | The date only component without time or time |
| | | zone information. For example, 2019 Aug. 14. |
| | | Given just a LocalDate attribute, it is not known |
| | | what timezone 2019 Aug. 14 refers to. |
| | LocalTime/LocalTimeRange | The time only component without date or time |
| | | zone information, For example, 3:15 PM. |
| | | Similar to LocalDate, given just a LocalTime |
| | | attribute, it is not known what timezone |
| | | 3:15 PM refers to. |
| | LocalDateTime/LocalDateTimeRange | The timestamp of both date and time |
| | | information, but without time zone information. |
| | | For example, 2019 Aug. 14 3:15 PM. Similar to |
| | | the other Local* types, it is not known what |
| | | timezone 2019 Aug. 14 3:15 PM refers to. |
| | ZoneId | A time zone ID, such as “Europe/Paris” or |
| | | “America/Los_Angeles”. Given a |
| | | LocalDateTime, it is assumed the same |
| | | request/path has a ZoneId which provides the |
| | | time zone context. This value is typically |
| | | automatically retrieved from the browser, so the |
| | | user currently never sets it directly. |
| | Duration | A duration of time, for example, 5 seconds, 10 |
| | | minutes and 15 seconds, or 5 years and 3 |
| | | months. The duration can cover any duration of |
| | | time, with the minimum granularity being |
| | | seconds. |
| | DealId | A unique identifier for most database entities at |
| | | deal (the company). This represents an id type |
| | | that's stored in almost all “_id” fields in the |
| | | database. For example, this is used for |
| | | “flightPlanId” (references the structured data of |
| | | a flight itinerary made by a customer), |
| | | “expertId” (supports explicit questions or pre- |
| | | filling where the consumer selects their expert), |
| | | “expertReviewSharedMedia” (user uploads |
| | | pictures, which results in Media objects |
| | | referenced by MediaId), and others. |

TABLE 3
Example Attributes

| validators | Zero or more validation rules for this attribute. Each validation rule can | |
|---|---|---|
| | be parameterized with zero or more key/value pairs, with each rule | |
| | accepting. For all entities (sellables, requests, path flows), these | |
| | validations are run before saving to the database, and the save is rejected | |
| | if any of them fail. At a minimal level, all failed validations will surface | |
| | human readable error messages, with most surfacing error messages that | |
| | are surfaced to the user. For the path system, a few validators have | |
| | special integration to surface to the user as they're typing, but all will be | |
| | checked regardless when the question is submitted. A few examples: | |
| | characterCount | Only applies to text attributes, accepts an |
| | | optional “min” and “max” parameter. If |
| | | either are omitted, it's assumed it's |
| | | unbounded. {min = 1, max = 10} means the |
| | | attribute must contain between 1 and 10 |
| | | characters, inclusive. {max = 100} means the |
| | | attribute must contain at most 100 values. |
| | | This rule is surfaced to the path system, so a |
| | | question is bound to an attribute with |
| | | characterCount, the text field checks this as |
| | | the user types |
| | contactAvailable | Only applies to text attributes, accepts a |
| | | required “type” parameter that should be a |
| | | contact type (PHONE, EMAIL). This checks |
| | | if this contact is registered with another user |
| | | that is not you. On failure, it surfaces an |
| | | error message (“An account is already |
| | | registered with this contact information”), |
| | | and an error tag of |
| | | “REQUIRES_LOGIN_TO_PROCEED” |
| | | which the UI uses to display the login link. |
| | smsCapablePhoneNumber | Only applies to text attributes, accepts no |
| | | parameters. Validates that the entry is a |
| | | valid phone number, and checks with Twilio |
| | | that the number can be contacted via SMS. |
| | idEntityType | Only applies to DealId attributes, accepts a |
| | | single “entityType” parameter. Validates |
| | | that the id is of a given type. To ensure |
| | | incorrect data isn't stored, all DealId |
| | | attributes include this validation. For |
| | | example, “expertId” has a validation |
| | | asserting the id entity type is |
| | | “businessUser”, and |
| | | “expertReviewsSharedMedia” has a |
| | | validation asserting the id entity type is |
| | | “media”. |

| | |
|---|---|
| categoryIds | The categories this attribute is associated with. This is currently used for |
| | search to determine which facets to query when searching sellables |
| | within the given category. For generic cross category attributes like |
| | “dominantHand” or “humanHeightInInches”, the category is set to the |
| | top level “PRODUCT” category, “SERVICE” category, or both. |
| attributeFunction | Tags used to mark the general function/purpose of the attribute, mostly |
| | used for recommendations. The code for this enumeration is shown in |
| | Table 8. |

Table 4 shows an attribute search function and Table 10 shows the associated code for this enumeration.

TABLE 4
Example Fields of an Attribute Schema with Code

| | |
|---|---|
| attributeSearchFunction | Tags used specifically to control the behavior of the attribute in |
| | search. The code for this enumeration is shown in Table 10. |

Table 5 shows how enumeration values are mapped between internal names and display names.

TABLE 5
Example Attributes

| enum value mapping | For enumeration attributes, this contains a mapping between internal | |
|---|---|---|
| data | names (e.g.: “HAMPTONS”) to display name (e.g.: “The | |
| | Hamptons”), and other optional metadata. The additional metadata | |
| | for each enum value is as follows: | |
| | categoryId | Category for this specific attribute value, |
| | | used by features like recommended lists. |
| | | For example, the “bikeAccessories” |
| | | attribute (entered in the path) has a top level |
| | | category of cycling, but the HELMET value |
| | | maps to Bike Helmets category, |
| | | CYCLING_CLEARS to Bike Cleats |
| | | category, BIKE_LOCKS to Bike Locks |
| | | category, etc. |
| | showInFeaturedFacet | Given this attribute is marked as a featured |
| | | facet (controlled through attributeSearch- |
| | | Function set to FEATURED_FACET), this |
| | | controls if this specific enumeration value |
| | | should be shown as a featured facet value. |
| | | This is so we can exclude values like “No |
| | | Preference” or “I don't know”, which are |
| | | required so we can record the choice via the |
| | | path, but we don't want to present as search |
| | | options since sellables don't contain them. |
| | iconlmagePath/ | image used for featured facet for this |
| | backgroundImagePath | enumeration value. Seems like both of these |
| | | are interchangeable right now. |
| | attributeFunction | Right now only used to mark the enum |
| | | value as an accessory. |

| | |
|---|---|
| display template | each attribute type has a default freemarker template to render it in a |
| | sensible form. For example, ranges will render as “x-y”, and |
| | enumerations will just render their description. Every attribute can |
| | override this though, and provide custom formatting. For example, |
| | “snowboardLengthCentimeters” has a custom display template of |
| | “${attribute.value} cm”, which allows us to display the cm suffix |
| | even though the attribute its self is stored as an integer type. A more |
| | complicated one is “humanHeightInInches”, which records a single |
| | number in inches, but displays as nice values like 6′ 6″. |

Inferring missing attributes has two major components; “mappers,” and the missing attribute metadata that says which and how a specific mapper should be used to fill it out. In certain situations, it is useful to infer values for missing attributes, for example when client 106 does not provide such data. Inferring missing attributes has two major components; “mappers,” and the missing attribute metadata that says which and how a specific mapper should be used to fill it out. Table 6 and Table 7 show example information for attached MissingAttribute metadata for a “charterDurationType.” Mappers may be hard coded within attribute storage 220, since these mappers are used for specific purposes, including gender, winter sports skill level, and so on. However, generic mappers are also supported for use in many cases. In these examples, “enum value mapper” may be created to take enumeration values from one attribute, and transform them into enum values for another attribute, using a mapping table. Attribute values contain the attribute schema and a list of zero or more values of the attribute schema data type.

TABLE 6
MissingAttribute metadata

| metadata | Arbitrary use case specific information that should be associated with the attribute | |
|---|---|---|
| | schema. Each attribute can have zero or more metadatas attached to it. This is | |
| | typically used when just attribute function tags aren't sufficient since additional | |
| | information is needed, but since metadata predates attribute function, sometimes | |
| | metadata is used when a simple attribute function tag would suffice. The | |
| | following is a comprehensive list of all of the metadatas we use: | |
| | CappedNumeric | Accepts “upperCap” decimal. In search, specifies that a |
| | | Decimal/DecimalRange attribute should be capped at a |
| | | given number, where when querying for that number, |
| | | everything above it should be included as well. For |
| | | example, when looking at the Price Range facet for an |
| | | expensive category like Yacht Charters, Price is |
| | | marked as “$50,000+”). Similarly, carats for diamonds |
| | | is capped at 10.00+. This behavior is toggled through |
| | | this metadata. |
| | DecimalScale | Accepts “scale” integer. In search, specifies how many |
| | | decimal points should be displayed. For example, |
| | | carats for diamonds has a scale of “2”, which is how |
| | | even UI knows to consistently display it in this fashion |
| | | even if the number is zero. |
| | FacetNameAlias | Accepts “alias” string. Used for SEO friendly urls for |
| | | faceted search, and must be globally unique. For |
| | | example, the “f-charter-duration-type” above is a facet |
| | | name alias for the “charterDurationType” attribute. |
| | | This is pretty commonly used; at the time of writing 36 |
| | | attributes defines a facet name alias. |
| | Hidden | Marks that the attribute should be hidden from the |
| | | consumer, and most default views. For example, |
| | | “firstName” is an attribute that's filled in during the |
| | | path, but the attribute is marked as Hidden so it's not |
| | | displayed in the final request attributes. We'll also use |
| | | this sometimes for attributes created just for branching |
| | | (e.g.: skiLengthKnown) that adds no value to display. |
| | SearchFacetFixedBucket | Accepts a list of numeric closed ranges. This is only |
| | | used for “charterCapacity”, and is how the facet is |
| | | rendered as the fixed “1-4”, “5-8”, “9-12”, 13+” |
| | | buckets. |
| | MissingAttribute | This is used to configure how the current attribute is |
| | | derived from other attributes. For example, |
| | | “charterDurationType” (enum that's either DAY or |
| | | TERM) has a missing attribute metadata that |
| | | automatically derives it from “durationHours”. There's |
| | | some complexity behind how derived attributes are |
| | | filled out, so this will be specified in greater detail later |
| | | on the document. |

TABLE 7
MissingAttribute metadata

| | |
|---|---|
| categoryId | charters. When a sellable or deal request is created, only attributes |
| | that match the category of the sellable/deal request are inferred. In |
| | this case, if the deal request was for golf, this attribute wouldn't be |
| | eligible for inferring. |
| mapper reference | CharterDurationTypeMapperReference. A reference is a |
| | combination of a name and optional arguments. For this case, there |
| | are no arguments needed to parameterize the mapper. |
| shouldSaveAsInternal | If the newly derived attribute should be marked as internal, which |
| | means it will be hidden by default. There are two cases for inferring |
| | an attribute; to derive commonly used attributes for back-end usage |
| | like powering recommendations, and to derive user visible attributes |
| | like charterDurationType. For this mapper, the value is “false” since |
| | it's user visible, but most of these will be “true” since showing many |
| | derived attributes to the user is redundant. |

TABLE 8
Example Attribute Function Code

| ∘ | /** |
|---|---|
| ∘ | * {@link AttributeFunction} is used to assign and |
| | classify an {@link |
| Attribute} a special purpose. | |
| ∘ | * The definitions are defined for each of these classified |
| | functions. |
| ∘ | * |
| ∘ | * The functions are useful to combine different |
| | Attributes when |
| building recommendations for a user. | |
| ∘ | * |
| ∘ | */ |
| ∘ | public enum AttributeFunction { |
| ∘ | |
| ∘ | /** |
| ∘ | * Primary Attributes define the importance |
| | of the Attribute for |
| identifying a product or a Service | |
| ∘ | * This can manifest itself as fundamental |
| | User intent about a |
| specific product or service or can be associated with a | |
| ∘ | * Sellable specification. Someone looking for |
| | a road bike or Golf |
| Wedges or Charter in Miami. | |
| ∘ | * |
| ∘ | * A Path should be restricted to very few |
| | Primary Functions. It |
| should be thought of as one thing that differentiates | |
| ∘ | * a Sellable from others |
| ∘ | * |
| ∘ | * Some examples of Primary Attributes include: |
| ∘ | * 1. Bike Type |
| ∘ | * 2. Golf Club type |
| ∘ | * 3. Charter Location |
| ∘ | * |
| ∘ | */ |
| ∘ | PRIMARY, |
| ∘ | |
| ∘ | /** |
| ∘ | * Secondary Attributes define other useful |
| | information that can be |
| used to further narrow down the specificity of | |
| ∘ | * a product or service or a Sellable Variation. |
| ∘ | * |
| ∘ | * Someone looking for a 56 cm Carbon fiber |
| | bike or Burton Men's |
| Snowboard | |
| ∘ | * |
| ∘ | * Some examples of secondary Attributes |
| | include: |
| ∘ | * 1. Bike Size |
| ∘ | * 2 . Dominant Hand |
| ∘ | * 3. Ski/Snowboard Length |
| ∘ | * 4. Gender preferences |
| ∘ | * 5. Brand preferences |
| ∘ | */ |

TABLE 9
Code Example

| ∘ | SECONDARY, |
|---|---|
| ∘ | |
| ∘ | /** |
| ∘ | * This is used to define other preference about the user or a |
| product or service. This includes things like | |
| ∘ | * users use case/need, experience, style, skill level etc. |
| These attributes can be used to further refine relevance | |
| ∘ | * ranking when we build recommendation for Products and |
| Services. | |
| ∘ | * |
| ∘ | * Some examples of information attributes includes: |
| ∘ | * 1. Golf Club angles. |
| ∘ | * 2. Bike riding years of experience |
| ∘ | * 3. Beginner, intermediate or expert style Attributes. |
| ∘ | * 4. First time buyer/user, etc. |
| ∘ | * 5. Model year |
| ∘ | * 6. Timeline |
| ∘ | */ |
| ∘ | INFORMATION, |
| ∘ | |
| ∘ | // For attributes associated with a User, this includes |
| personal information like phone number, email etc | |
| ∘ | PERSONAL_INFORMATION, |
| ∘ | |
| ∘ | /** |
| ∘ | * Defines an Attribute that is of Accessory type associated |
| with a Parent Sellable path. | |
| ∘ | * Some examples include: |
| ∘ | * 1. Bike Helmets |
| ∘ | * 2. Snowboard/Ski Goggles |
| ∘ | */ |
| ∘ | ACCESSORY, |
| ∘ | |
| ∘ | /** |
| ∘ | * DISPLAY_PRIMARY attributes define the importance |
| | of an |
| attribute when a request is displayed. It is used in UI and | |
| ∘ | * messaging templates. |
| ∘ | */ |
| ∘ | DISPLAY_PRIMARY, |
| ∘ | |
| ∘ | /** |
| ∘ | * TAGGABLE function is used to identify the Attributes to |
| show as taggable suggestions to the experts | |
| ∘ | * when saving ExpertCuratedltems |
| ∘ | */ |
| ∘ | TAGGABLE, |

| | |
|---|---|
| | ∘ |
| ∘ | } |

TABLE 10
Example Attribute Search Function Code

```
/**
  * AttributeSearchFunction is used to assist the Search system to
identify whether a particular {@link Attribute}
  * is relevant for the Search(ing) of the Parent entity to which it
belongs and how it should be treated for indexing
  * and other search operations.
  *
  */
public enum AttributeSearchFunction {
    /**
      * Marks an {@link Attribute} to be indexed as a Facet
      */
    FACET,
    /**
      * Marks an {@link Attribute} to be treated specially
      for SERP pages.
      */
    FEATURED_FACET,
    /**
      * Marks an {@link Attribute) to be indexed as regular
      field of the
parent entity
    */
    FIELD_INDEX,
      /**
      * By default the {@link AttributeType} is used to
      structure the facets
into their types and when the facet results
      * are parsed they are mapped based on the type
      specific aggregations.
      * This results in the bucketed aggregation for
      keyword/string types
and stats aggregation for the numeric types
      * that gives a range of values instead of buckets.
      * In some cases, we might want to override the
      behavior of these
types, for example if you we want to see the
      * numeric values as bucket values instead of range.
      *
      * Use this type to perform such transformation during
      indexing or
search queries.
      * The values will be automatically converted to their
      stringified
value both during indexing and query.
      *
      */
```

TABLE 11
Code Example

```
  OVERRIDE_FACET_TYPE_AS_KEYWORD,
  /**
  * When a {@link RawAttribute} is linked to this specific attribute's
{@link Schema}, the raw attribute value will
  * be used as a keyword facet type.
  *
  * This is useful for when the standardized {@link Attribute} is a
number, but the raw attribute contains more context
  * that is lost. For example, snowboard sizes have multiple variants at
the same size, e.g.: “159W” for “wide”.
  *
  * If there is no matching raw attribute, this attribute will not be
indexed.
  */
  OVERRIDE_FACET_RAW_ATTRIBUTE_AS_KEYWORD,
  /**
  * Used to Order display facet terms by their values in ascending order
  * Does not apply to range attributes
  */
  ORDER_FACET_TERMS_BY_LO_HI,
  /**
  * Similar to {@link #ORDER_FACET_TERMS_BY_LO_HI},
  except that the
keyword will be sorted numerically first (extracting
  * any numeric portion out of the keyword), and then alphabetically.
  */
  ORDER_FACET_TERMS_BY_LO_HI_AS_NUMERIC,
  /**
  * Used to Order display facet terms by their values in descending
order
  * Does not apply to range attributes
  */
  ORDER_FACET_TERMS_BY_HI_LO,
  /**
  * Used to Order display facet terms by their document count
occurrences in descending order
  * Default if none specified.
  *
  * Does not apply to range attributes
  */
  ORDER_FACET_TERMS_BY_DOC_COUNT,
  /**
  * Orders display facet terms by the order they're defined in the
attribute enum definition.
  * Only applies to enum attributes.
  */
  ORDER_FACET_TERMS_BY_ENUM_DEFINITION_ORDER
}
```

Table 12 shows a list of example trigger events used within system 100 of FIG. 1, in certain embodiments.

TABLE 12
Example Trigger Events

| | |
|---|---|
| pathCompleted | leadCampaignStarted |
| abandonedOrderExpertFollowup | systemCuratedItemsActivated |
| fullPaymentPartial | expertProfileApprovedByOnboardingSpecialist |
| remainingBalancePaymentFailed | consumerInterestedInCuratedOrder |
| newLeadexpertApplicationApproved | fullPaymentCompleted |
| incompletePathRemoveReplyReceived | expertProfileApproved |
| orderAbandoned | remainingBalancePaymentPartial |
| orderLineItemPendingShipping | newSupportMessage |
| expertCuratedBookableOrderActivated | expertCuratedItemsActivated |
| expertApplicationApprovedByOnboardingSpecialist | curatedListViewed |
| feedbackRequestedByExpert | newSupportTask |
| referralRequestedByExpert | consumerReviewedExpert |
| leadArchived | newOrderEscalation |
| userCreated | orderLineItemReady |
| escalationClaimed | expertCuratedOrderListActivated |
| resendCuratedOrderRequested | orderSubmitted |
| depositPaymentPartial | remainingBalancePaymentCompleted |
| depositPaymentCompleted | incompletePathReplyReceived |
| qualityConversationEstablished | pathStarted |
| consumerMessaged | expertProfileSubmitted |
| depositPaymentFailed | escalationCreated |
| orderActedOn | expertActivated |
| escalationClosed | expertReferralCreated |
| simpleCuratedOrderCreated | expertCuratedCustomOrderActivated |
| expertProfileChangeRequestedByOnboardingSpecialist | expertPendingDeactivation |
| incompletePathBrowseReplyReceived | fullPaymentFailed |
| expertProfileChangeRequested | subsequentRequest |
| sellableViewed | expertMessaged |
| expertShiftCountUpdated | orderLineItemShipped |
| orderLineItemClaimed | consumerInitialActionStarted |
| systemCuratedItemSurveyCreated | orderLineItemReceived |
| leadConsumerNewUnreadMessage | inactiveLeadExpertFollowup |

In one embodiment, attribute storage 220 has over five-hundred attribute schemas defined. These attribute schemas allow data to be programmatically used to automatically build recommendations around certain attributes.

### Multi-Channel Interface

Multi-channel communication 214 assigns a unique contact number 265 (e.g., a text/telephone number) to each advisor 102 and assigns a unique email address 267 to each advisor 102. For example, when advisor 102 joins system 100 for the first time, multi-channel communication 214 assigns unique contact number 265 and unique email address 267 to advisor 102. Contact number 265 and email address 267 remain consistent (e.g., do not change and are not used for anyone else) for advisor 102 such that when a previous client uses contact number 265 and/or email address 267 outside of any conversation 270, system 100 will automatically forward that communication to advisor 102. Where the corresponding advisor 102 is no longer working as an advisor with system 100, system 100 may automatically forward the communication to another suitable advisor 102.

Multi-channel communications 214 may implement one or more of an application interface 262, a web interface 264, a SMS interface 266, and an email interface 268, and may implement other communication interfaces as needed. Application interface 262 provides communication with a client application 282 running on a mobile communication device 280 (e.g., a smartphone, tablet computer, etc.) of client 106(1) and with an advisor application 290 running on a mobile communication device 288 of advisor 102(1). Web interface 264 may implement one or more web sites that allow (a) client 106(2) to use a browser 286 running on a computer 284 (e.g., a desktop, laptop, mobile, table or any other type of computer) to access system 100 and (b) advisor 102(2) to use a browser 294 running on a computer 292 (e.g., a desktop, laptop, mobile, table or any other type of computer) to access system 100. Application interface 262 and/or web interface 264 may also indicate when each client 106 and/or advisor 102 is online (e.g., logged into system 100). SMS interface 266 allows system 100 to communicate with clients 106 using short-message-service (e.g., texts), such as when client 106 has a message waiting but has not logged into system 100 for a defined period, or when texting is a preferred method of communication for client 106. Similarly, email interface 268 allows system 100 to communicate with clients 106 using email, such as when email is the preferred communication method for client 106. Multi-channel communication 214 manages these different communication methods seamlessly within system 100, allowing the client 106 to change between methods and automatically adopting the method used by the client for following communications.

In certain embodiments, when client 106 uses a particular communication channel (e.g., sends a message to advisor 102 using SMS), multi-channel communications 214 automatically switches future communications to use that channel (e.g., system 100 may respond using SMS). However, if the communication channel does not appear to be successful (e.g., system 100 sends a SMS to client 106, but client 106 has not responded within a defined period), multi-channel communications 214 may resend the message using a different channel (e.g., via client application 282 and/or email interface 268). Advantageously, multi-channel communication 214 makes communication familiar and natural for both client 106 and advisor 102.

SMS interface 266 automatically forwards text messages received for contact number 265 to the appropriate conversation 270 within sales pipeline 114 for viewing by advisor 102. Any text message sent to contact number 265 is delivered to system 100 (e.g., not delivered directly to a mobile device of advisor 102). Similarly, all email messages sent to email address 267 are delivered to system 100 and are then forwarded to the appropriate conversation 270. Advantageously, advisor 102 may view the messages in the correct context of conversation 270. When advisor 102 sends a text message and/or email message to client 106, multi-channel communication 214 automatically sends the message from the appropriate contact number 265 and/or email address 267. Advantageously, to client 106, the communications with advisor 102 appears personal and direct to further build confidence in conversation 270.

Where multi-channel communication 214 determines that client 106 is currently online (e.g., connected through client application 282 and/or browser 286), messages from advisor 102 to client 106 are first sent through the online channel (e.g., via application interface 262 or web interface 264). However, where the client is not online, or has not read a waiting message for a defined period, multi-channel communication 214 may automatically send the waiting message via one or both of SMS interface 266 and/or email interface 268. advantageously, through multi-channel communication 214, messages are not lost when a particular communication channel fails.

Multi-channel communication 214 makes communication between client 106 and advisor 102 simple, natural and convenient for client 106. For example, to continue a conversation, client 106 may use any convenient channel (e.g., text, email, web browser, application) and is not otherwise restricted. Different environments of client 106 may make one communication channel more convenient that others, and/or may make other communication channels less convenient. Advantageously, multi-channel communication 214 automatically switches between channels. Further, multi-channel communication 214 combines the multi-channels into a single conversation thread for advisor 102, such that advisor 102 is not affected by the different channels used by client 106. Therefore, advisor 102 sees the entire conversation irrespective of which communication channel was used. Where client 106 switches channels (e.g., from email to SMS), system 100 may automatically include one SMS message that introduces the conversation and includes a link that allows client 106 to review previous communications without having to search for previous emails.

### Distributed Queue Manager

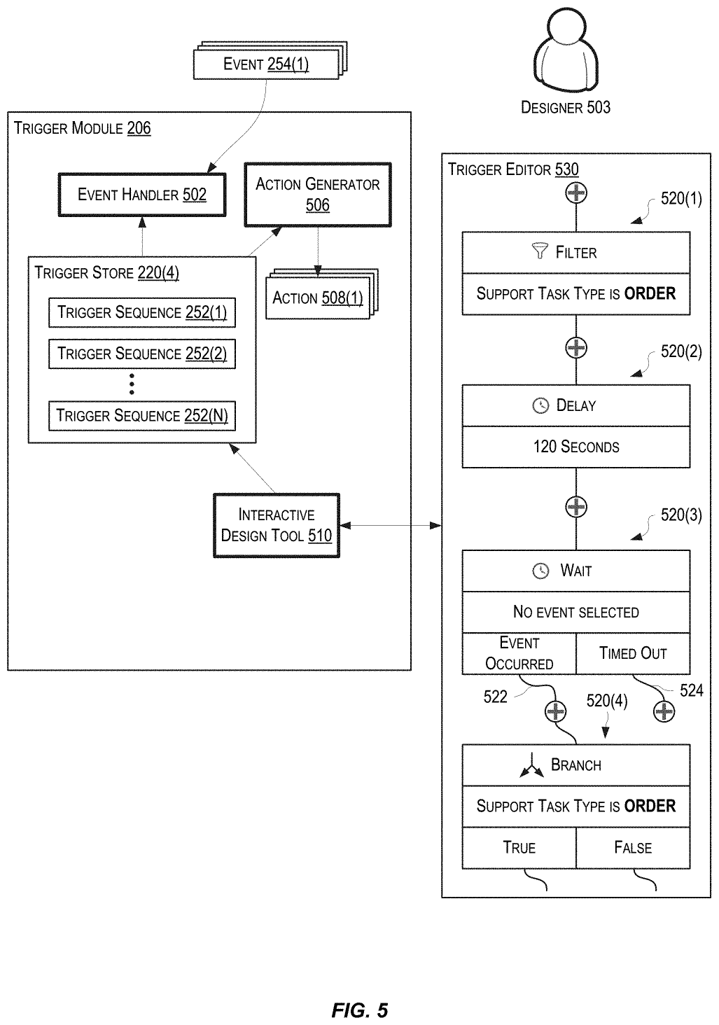

As shown in FIG. 2, within system 100, distributed queue manager 212 implements a distributed queue 213 for queuing events 254 (see FIG. 5) within system 100 and providing scheduling of an event 254 and synchronization of multiple events 254. Distributed queue 213 supports processing of events 254 among distributed processors with at least one deliverability guarantee, either immediately or scheduled at a future time, and optionally groups events 254 based at least in part upon a synchronization key associated with the event 254 within distributed queue 213. Where a group of events 254 have the same synchronization key, distributed queue manager 212 guarantees that only one of the events is processed at any time across all distributed processors, without blocking other events with a different synchronization key and without blocking events with no synchronization key.

### Path Module

FIG. 3 is a functional diagram illustrating example operation of path module 202. FIGS. 2 and 3 are best viewed together with the following description. Path module 202 has two major components; path schemas 308 that define possible path flows for a particular category (e.g., golf) and path flows (e.g., path flow 110) that are generated from one path schema 308 to capture the client responses as request details 113. Each path schema 308 defines a structure (question types, answer types, order of questions, etc.) for a category that may be used to create each path flow 110 that captures request details 113 of client 106.

A designer 303 (e.g., an operator/manager) of system 100 may use an interactive design tool 302 to interactively and graphically create and store at least one path schema 308 in a path store 220(3). In certain embodiments, each path schema 308 may be associated with a specific category 107 (e.g., winter sports or golf) and is used to generate path flow 110 for a particular client 106. Unlike conventional survey type interactive screens, each question and/or answer of path flow 110 may include an attribute that links the question/answer with specific products 217 of e-commerce module 216, one or more of categories 107, and/or other parameters of system 100. For example, where client 106, during interaction with path flow 110, selects winter sports, subsequently asked questions/answers may include a winter sport attribute, such that these questions/answers are specifically related to that category. For the golf category, where the product is a golf club, questions and answers relating to one of shaft stiffness and shaft length may have corresponding attributes of shaft stiffness and shaft length. This provides a distinct advantage over prior art survey procedures, where answers alone are recorded and the answer must be interpreted in view of the question to discern the relevance of the answer. By including attributes with questions of path flow 110 and corresponding attributes with answers in request details 113 (e.g., answers and selections provided by client 106), path flow 110 prompts client 106 to provide request details 113 that are immediately usable by system 100.

When a new lead 109 is received from lead generator 108, path module 202 may operate automatically, without direction from any person, and invoke a selection algorithm 306 to generate, based, at least in part, upon category information of lead 109, one path flow 110 based upon path schema 308 from path store 220(3). For example, where lead 109 indicates an interest of client 106 in the golf category, selection algorithm 306 selects one path schema 308 corresponding to the golf category and generates path flow 110. Each category has at least one path schema 308, for example where each path schema 308 corresponds to a sub-category. Using the above example, the golf category may have sub-categories of golf clubs and golf carts, each with a corresponding path schema 308 that may be used to generate a more relevant path flow 110 for client 106.

Path module 202 invites client 106, identified within new lead 109, to interact, via web interface 264 (or application interface 262 where client 106 uses client application 282), with the generated path flow 110, and collects request details 113 (e.g., selections, textual responses, timing of response, and so on) from that interaction. When client 106 has completed path flow 110, path module 202 may invoke a classifier 310 (e.g., an artificial intelligence based analyzer) to process request details 113 and determine intent 112 of client 106 towards one or more products 105. For example, classifier 310 may determine intent 112 as an experienced golfer in need of a full set of new golf clubs. Advantageously, through operation of path module 202, system 100 learns more detail of client 106, including intent 112 of client 106 towards product 105.

System 100 relies upon advisors 102 to provide advice to clients 106 such that the clients purchase products through e-commerce module 216. Path module 202 may also be used by system 100 to recruit new advisors 102. See “Automated Advisor Recruitment” below for further details.

Path module 202 also implements path flow statistics that allow a designer of path schemas 308 to determine which paths, questions, and branches are more effective than others. See “Flow Optimizer” below.

### Workload Optimizer

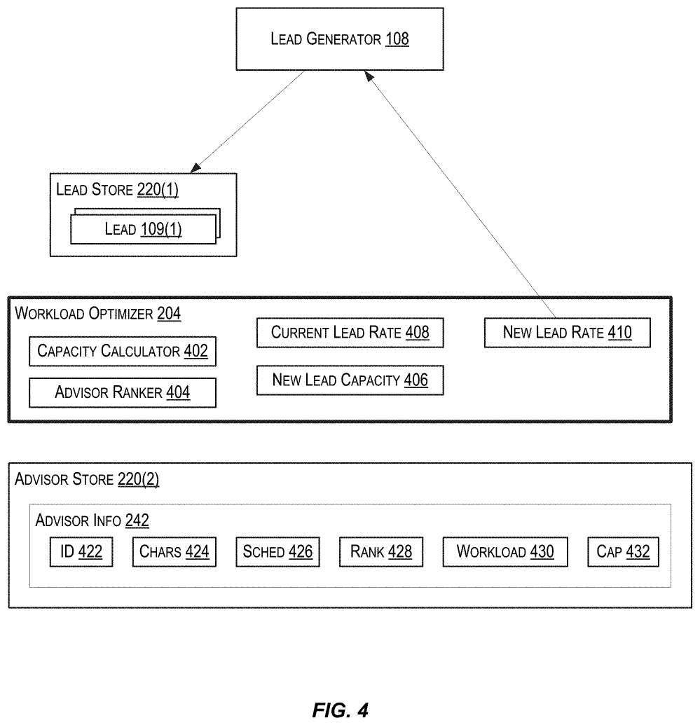

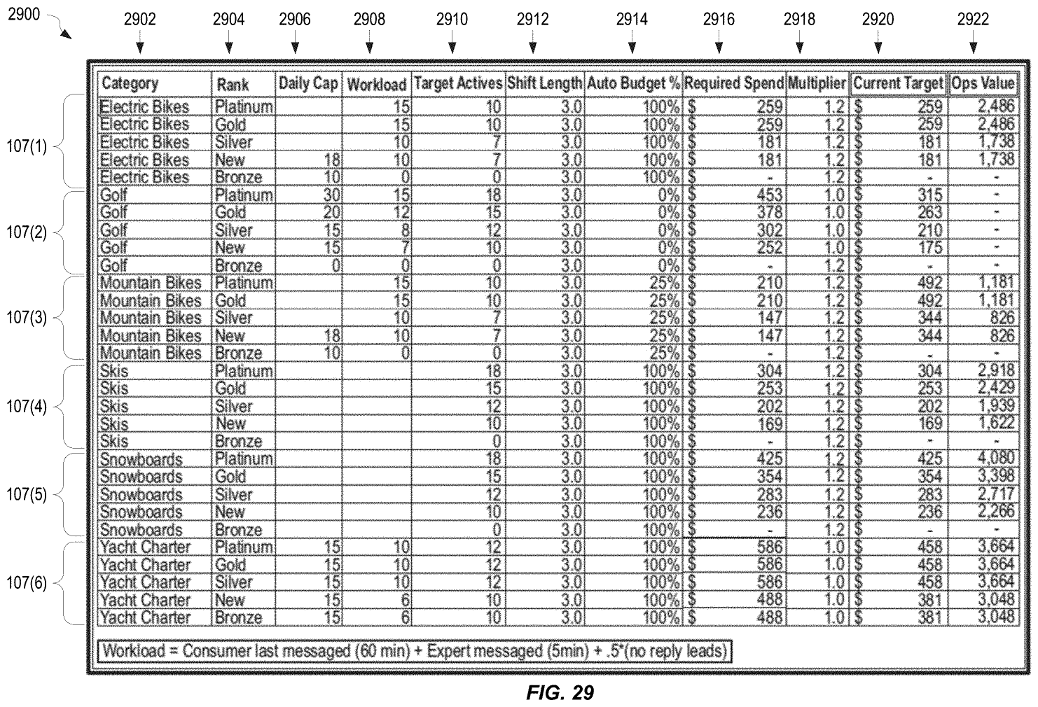

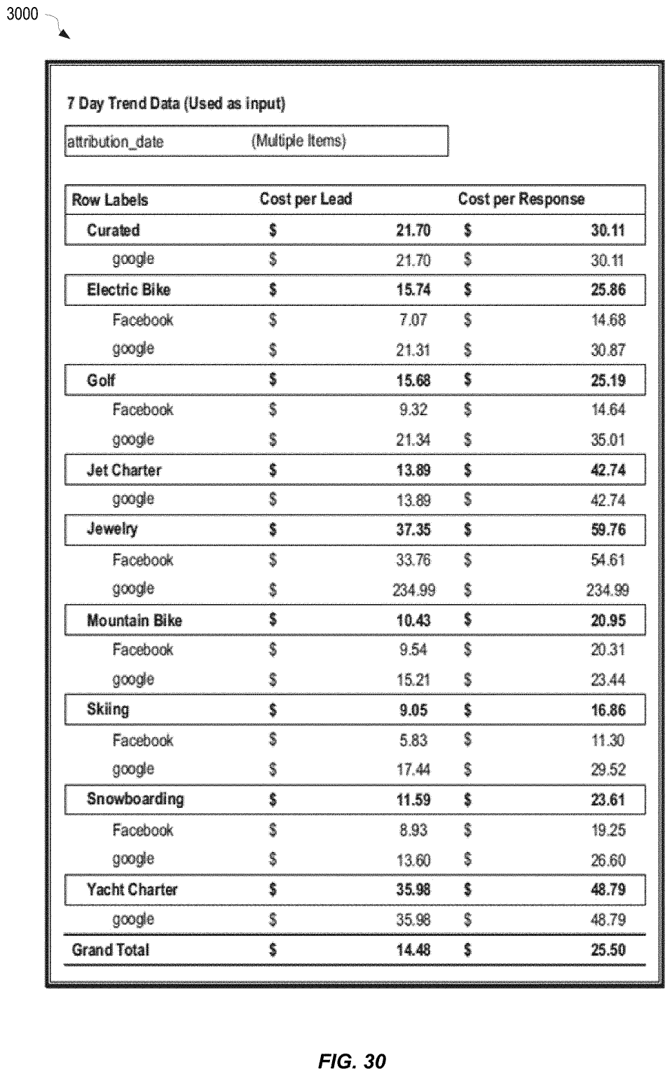

FIG. 4 is a functional diagram illustrating example operation of workload optimizer 204, of FIG. 2. FIG. 29 shows a table 2900 with example data used to balance workload of system 100. FIG. 30 is a table 3000 illustrating example seven-day trend data used as input to the calculations of table 2900 of FIG. 29. FIGS. 2, 4, 29 and 30 are best viewed together with the following description.

System 100 pays money (referred to as “spend”) to receive new leads 109 from lead generator 108. Conventionally, spend is controlled by a marketing campaign; however, workload optimizer 204 of system 100 automatically controls spend for each category 107. Where spend is too high, too many new leads 109 are received from lead generator 108 and some may not get assigned to, or accepted by, an advisor 102; thus, the money spent to receive the lead is wasted. On the other hand, when system 100 receives too few leads 109 from lead generator 108, one or more advisors 102 may not have enough leads 109 to follow, resulting in the advisor becoming less engaged with system 100. Workload optimizer 204 controls the number of new leads 109 acquired from lead generator(s) 108 based, at least in part, on real time capacity of system 100 to process these leads, and availability of advisors 102. Accordingly, workload optimizer 204 automatically balances the spend against the capacity of system 100.

In the example of table 2900, column 2902 lists categories 107 of system 100 including electric bikes 107(1), golf 107(2), mountain bikes 107(3), skis 107(4), snowboards 107(5), and yacht carter 107(6). However, more or fewer categories may be included without departing from the scope hereof. Column 2904 groups advisors 102 within each category based upon rank 428. As described in more detail below, advisor ranker 404 (FIG. 4) determines rank 428 for each advisor 102 based upon ability, as measured by their historical performance (e.g., sales numbers—see sold folder 716, FIG. 7) with advisor interface system 100. In this example, rank 428 is one of (highest to lowest) platinum, gold, silver, new, and bronze. An advisor 102 with a platinum rank 428 is able to handle more simultaneous conversations and achieve more positive results than an advisor with a lower rank 428. A daily cap may be defined for each Based upon the category and the rank,

Each advisor 102 may provide a working schedule 426 that defines when advisor 102 will be online with system 100. Workload optimizer 204 uses at least rank 428 and schedule 426 to determine a work capacity of advisor 102. Further Workload optimizer 204 then determines the workload (column 2908) and capacity of system 100 more accurately, workload optimizer 204 evaluates each rank (e.g.,) of advisor in each category.

In certain embodiments, when workload optimizer 204 determines that new leads 109 are not being assigned to advisors 102 (e.g., because advisors are offline or are already too busy to accept new leads), workload optimizer 204 may automatically notify offline advisors 102 that new leads 109 are available. Particularly, workload optimizer 204 optimizes the workload (e.g., current number of active conversations 270 taking place) based upon a number of leads 109 requested and the number of advisors 102 online, to maximize throughput of system 100. Capacity of system 100 may be defined as a total number of active conversations 270 that may be currently handled, which is computed as a sum of the number of advisors 102 by rank tier (e.g., bronze, silver, gold, platinum) times an average number of active conversations 270 one advisor 102 in that rank tier can handle. For example, at the lowest rank tier of bronze, each advisor may only handle one conversation at any one time; at the silver rank tier each advisor may handle two conversations at any one time; at the gold rank tier each advisor may handle four conversations at any one time; and at the platinum rank tier each advisor may handle eight conversations at any one time.

Workload optimizer 204 may automatically decrease workload of system 100 when fewer advisors 102 are online. Workload optimizer 204 modulates, in real-time, an amount of money spent to acquire new leads 109 through lead generator 108 (e.g., a paid campaign based on the availability of resources (advisors 102) to work on these new leads. For example, workload optimizer 204 automatically reduces the amount of money spent on new leads when fewer advisors are online, and automatically increases the amount of money spent on obtaining new leads when more advisors come online. In certain embodiments, the amount of money spent on new leads is a combination of a marketing campaign budget. In certain other embodiments, the amount of money spent on new leads is an amount bid for a click against an ad platform, such as Facebook. When the amount of money spent on new leads is increased (or the bid for the click is increased), the number of new leads that sent to system 100 increases. Conversely, when the amount of money spent on new leads is decreased (or bid for the click is decreased), the number of new leads sent to system 100 decreases. In certain embodiments, adjustment of the amount to spend on new leads has an almost instantaneous effect on the number of new leads being received by system 100. In other embodiments, an effect of adjustment of the amount to spend on new leads may take more time (e.g., hours) to affect the number of new leads being received by system 100.

In one embodiment, system 100 automatically increases capacity when the workload increases (e.g., when a number of leads receive by system 100 increases), by notifying advisors 102 to come online. In another embodiment, system 100 automatically adjusts other factors (e.g., game dynamics—brownie points, stars, points to get to the next rank tier) or implements other techniques to entice more advisors to come online.

System 100 operates with many advisors 102, each with his or her own operating schedule. As such, system 100 does not impose a working schedule on advisors 102. Each of the plurality of advisors 102 are experienced to advise clients 106 in at least one of the categories 107 supported by system 100, and advisors 102 collectively cover all supported categories 107. A capacity for system 100 to handle new leads 109 is based, at least in part, upon a number of available (e.g., online, or expected to be online) advisors 102, advisor current workload, and advisor capacity to handle more leads. System 100 includes an advisor store 220(2) that has advisor information 242 for each advisor 102. Advisor information 242 includes a unique identifier (ID) 422, advisor characteristics 424, a work schedule 426, a rank 428, a current workload 430, and a workload cap 432. Advisor ID 422 and characteristics 424 (e.g., gender, age, geographic location, qualifications, skills, other demographics, and so on) uniquely identify the advisor 102 and define the advice that advisor 102 may provide to client 106. Schedule 426 defines an expected work schedule for advisor 102. For example, schedule 426 may define a number of hours advisor 102 is expecting to be logged in to system 100 each day, indicate when advisor 102 is unavailable, and so on.

Workload optimizer 204 includes an advisor ranker 404 that may be invoked, at intervals, to determine a current rank 428 of each advisor 102 within system 100 based upon current and past performance of each advisor 102. For example, system 100 tracks conversations 270, curations 116, and client commitments 272 (illustratively shown within sales pipeline 114), a number of current conversations 270 that advisor 102 is participating in, how may leads 109 resulted in a positive outcome, and so on, to determine one or more of workload 430 and rank 428 of each advisor 102. Rank 428 indicates the ability and success of advisor 102 in providing advice to clients 106, and may therefore be used to select one of the plurality of advisors 102 registered with system 100 for handling a new lead 109.

Workload optimizer 204 includes a capacity calculator 402 that is invoked to determine a new lead capacity 406 for system 100 for an upcoming period (e.g., the next day) based, at least in part, upon a current workload 430 of each advisor 102, schedule 426 of each advisor 102, and a workload cap 432 of each advisor 102. For example, based upon current workload 430 of each advisor 102, capacity calculator 402 may determine how much spare capacity each advisor has. Capacity calculator 402 may then compare a current lead rate 408 (e.g., a current number of leads per day being received) against new lead capacity 406 (e.g., an estimated number of leads system 100 can handle) to determine a new lead rate 410 (e.g., a number of leads required for the upcoming period). New lead rate 410 may also be known as a lead spend rate, since it defines a marketing cost of obtaining the required number of new leads from lead generator 108.

In certain embodiments, workload optimizer 204 may also invoke capacity calculator 402 and advisor ranker 404, at intervals (e.g., hourly), to determine how well system 100 is currently handling new leads 109 from lead generator 108. For example, a current lead rate 408 (e.g., a rate at which new leads 109 are being supplied by lead generator 108) may be based, at least in part, upon previously determined new lead rate 140 for the current period. However, where advisors 102 are unavailable, advisor matcher 210 may be unable to assign new leads 109 to advisors 102. Accordingly, when capacity calculator 402 determines that new leads 109 are not being assigned and/or handled, capacity calculator 402 may automatically and immediately pause marketing spend for the remainder of the current period (e.g., a remainder of the current day), such that lead generator 108 stops sending new leads to system 100.

Workload optimizer 204 thereby controls marketing spend based upon a workload capacity of system 100 for handling new leads. Such control is necessary because when too many new leads are received, they cannot be handled efficiently by advisors 102, and therefore are less likely to have positive results. Conversely, when system 100 does not receive sufficient new leads 109, advisors 102 may not have sufficient client 106 to maintain interest, and therefore these advisors 102 may become less involved with system 100, such that system 100 efficiency and workload capacity reduces.

### Trigger Module

FIG. 5 is a functional diagram illustrating example operation of trigger module 206 of FIG. 2. FIGS. 2 and 5 are best viewed together with the following description. Trigger module 206 is a complex tool that allows designers (e.g., marketing and operations personnel) to automates prompts and responses for advisors 102, clients 106, and support agents. Within system 100, a triggering event 254 (e.g., one of over sixty-five or more different events within system 100) may be evaluated against an infinite combination of conditions, delays, branches, and other events. Advantageously, a designer 503 may create at least one trigger sequence 252 that is invoked when a corresponding event 254, defined within the trigger sequence, occurs. Accordingly, designer 503 may create trigger sequences 252 to automatically create personalized and relevant message sequences that may be sent from advisors 102 to clients 106. Advantageously, an interactive design tool 510 allows designer 503 to create and edit trigger sequences 252 to incorporate new scenarios and/or ideas. Interactive design tool 510 is similar to interactive design tool 302 of FIG. 3, and implements a trigger editor 530 that allows designer 503 to interactively and graphically create and store at least one trigger sequence 252 in trigger store 220(4).

Each trigger sequence 252 is constructed of one or more of the following: a trigger component, a delay component, a filter component, a branch component, an action component, and a template component. The trigger component identifies the event that initiates the trigger sequence. FIG. 43 defines a list 4300 of example trigger events 254 used within system 100. For example, the trigger component may define the triggering event as OrderLineItemShipped, wherein the trigger sequence is invoked in response to a new event 254 with a type of OrderLineItemShipped. The delay component defines a period (e.g., fifteen minutes, one day, etc.) for which the trigger sequence is delayed. For example, a delay component may be added to space out messages being set to a client so that the client has a reasonable amount of time to respond. The filter component applies a Boolean condition that must be satisfied for execution of the trigger sequence to proceed with the next trigger component. For example, when the defined condition evaluated to false, further execution of the trigger sequence is cancelled. For example, the filter component may be used to target the trigger sequence to a specific audience, such as clients looking for snowboards, or paying clients. The branch component is similar to the filter component but causes the trigger sequence to follow one of two different paths based upon either a Boolean condition or an A/B test. For example, the branch component allows the trigger sequence to send different messages in different scenarios. The action component causes the trigger sequence to initiate an action such as, but not limited to, one of: sending a templated message, sending an SMS, sending an email, sending a notification, creating a support task, archiving a conversation, and reassigning a lead. The template component selects a message template for generating a new message. For example, for example based upon A/B testing, the template component may select a message template that is used to send a message to a client.

In one example, trigger sequence 252(1) is formed of three components, a trigger component, a delay component, and an action component. The trigger component defines the triggering event as “OrderLineItemShipped,” which causes trigger sequence 252(1) to be invoked whenever system 100 generates an OrderLineItemShipped event 254. The delay component defines a period of fifteen minutes, which causes trigger sequence 252(1) to pause for fifteen minutes when invoked. The action component is a send notification action, that causes trigger sequence 252(1) to send a notification. Accordingly, when an item ships, as determined by e-commerce module 216 for example, event 254 of type OrderLineItemShipped is generated and trigger sequence 252(1) is invoked to automatically send a notification to the ordering client 106 fifteen minutes later. Trigger sequences 252 may have a significantly more complex set of components that control automatic functions within system 100.

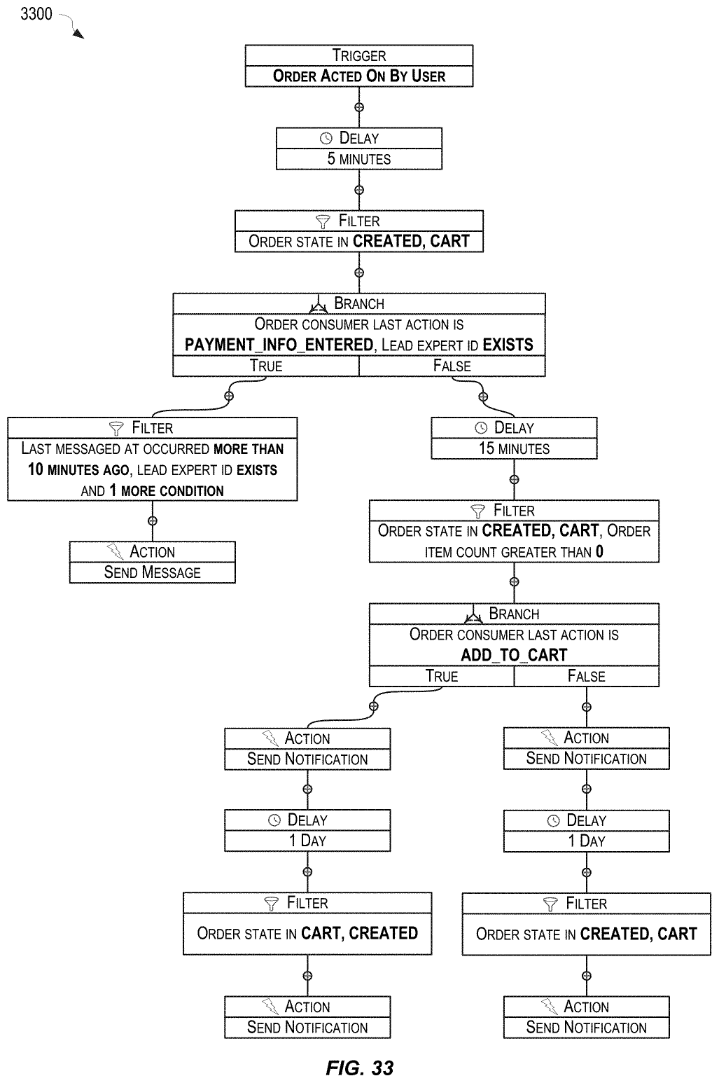

FIG. 33 shows one example abandoned cart trigger sequence 3300 that branches twice, accounting for three potential outcomes, to send different messaging to client 106.

During operation, system 100 generates a plurality of events 254, such as one of a message, an action, and other such occurrences within system 100. These events 254 are queued within distributed queue 213 and processed by an event handler 502 of trigger module 206. In certain embodiments, event handler 502 may be invoked as each event 254 occurs. In other embodiments, event handler 502 may be invoked at intervals to handle any events 254 that may have occurred during that interval. Event handler 502 processes each event 254 against each of the plurality of trigger sequences 252, stored within trigger store 220(4). Trigger module 206 is a powerful tool that allows a designer, a business developer, and/or marketing person develop at least one trigger sequence 252 that allows system 100 to automatically respond to certain events and/or conditions that are related to conversations 270.

Trigger module 206 may be used in different areas of system 100 to implement one or more of: escalation management, new client on-boarding, client re-engagement, and order fulfillment workflow. For example, trigger module 206 may be used to monitor a service level agreement (SLA) for an advisor to respond to a message from a new client 106. If there is no response from an advisor within a first period, trigger module 206 escalates the issue by sending notifications to advisors currently online. If there is still no response from an advisor within a second period, trigger module 206 escalates the issue further by sending notifications to all advisors. If there is still no response from an advisor within a third period, trigger module 206 escalates the issue further by sending notifications to a support team of system 100. In another example, trigger module 206 may send an alert to an advisor when an order has not resulted in a corresponding shipment within three days. In another example, trigger module 206 may re-engage clients by sending emails based on their actions in system 100, such as when a client views a product or when a client adds an item to an online shopping cart but then does not follow through with an order.

Each trigger sequence 252 may include at least one trigger component 520 that is processed in response to a triggering event 254. For example, one trigger sequence 252 may include trigger components 520 that evaluate certain conditions and generate at an action 508 to prompt, at an appropriate time, advisor 102 to send a message to client 106. In the example of FIG. 5, a filter component 520(1) specifies a condition of “support task type is order” that must be satisfied before trigger sequence 252 proceeds. Accordingly, trigger sequence 252 proceeds with component 520(2) only when that condition is met; otherwise trigger sequence 252 may terminate and event handler 502 may proceed with a subsequent trigger sequence 252 of trigger store 220(4). Delay component 520(2) specifies a delay of two minutes for trigger sequence 252. A wait component 520(3) may indicate that trigger sequence 252 should wait until a specified event occurs or a timeout occurs. Accordingly, in the example of FIG. 5, trigger sequence 252 proceeds to step 520(4) only when the specified event 254 occurs.

In one example is using wait component 250(3), during conversation 270 between client 106 and advisor 102, event 254 is generated when advisor 102 sends a message to client 106 and trigger sequence 252 is initiated. Wait component 520(3) is defined to wait for either a defined period (e.g., a reasonable period for client to respond, such as eight hours, one day, etc.) or for a subsequent event 254 that indicates that client 106 has responded. When the subsequent event 254 occurs before the wait period expires, trigger sequence 252 follows a first path 522, and when client 106 does not respond within the defined wait period, trigger sequence 252 follows a second path 524. Accordingly, trigger sequence 252 behaves intelligently by causing an appropriate action based upon whether the client does or does not respond. For example, the action may prompt advisor 102 to send a follow-up message to client 106 to keep the conversation going. Branch component 520(4) causes trigger sequence 252 to follow one of two paths based upon a defined Boolean condition. In the example of FIG. 5, branch step 520(4) follows a first branch when the support task type is order, otherwise it follows a second branch. Advantageously, trigger sequences 252 may be created to invoke action generator 506 to generate appropriate actions 508 based upon complex scenarios and conditions.

Trigger module 206 may communicate with any of client 106; advisors 102, for example when their applications have been approved; and support agents, for example when a new escalation has been created.

### Flow Optimizer

As noted above, interactive design tools 302 and 510 are similar. Accordingly, path schemas 308 and trigger sequences 252 have certain similarities in the way they are developed. To aid development of path schemas 308 and trigger sequences 252, path module 202 and trigger module 206 may track flow through each corresponding path flow 110 and trigger sequence 252, indicating how many times each route (and/or each step or component) through the flow has been used. Accordingly, designers 303/503 may review their corresponding flow/sequences 110/252 to determine how many times each route, step, or component is used. For example, a route (or step) that has no, or few, uses, may indicate that the corresponding condition, or set of conditions, is incorrect. In another example, designer 303/503 may notice that a route is followed frequently and that it may be advantageous to include additional branches to learn more information of the clients following those paths.

### Sales Pipeline

For each advisor 102, sales pipeline 114 tracks at least one conversation 270 between the advisor and a client 106 and may include a commitment 272 (e.g., agreement to purchase) of client 106 for product 105. System 100 may generate a trigger event 254 based upon certain activity within system 100. For example, based upon interactions of one or both of advisor 102 and/or client 106, sales pipeline 114 may generate trigger event 254 indicating the interaction within sales pipeline 114. In another example, lead database 220 may generate trigger event 254 when a new lead 109 is received by lead database 220.

FIG. 6 is a functional diagram illustrating example operation of sales pipeline 114 of FIG. 2. FIGS. 2 and 6 are best viewed together with the following description. Each advisor 102 uses sales pipeline 114 to track leads 109 assigned to the advisor, track a status of these leads, track conversations 270 for these leads that the advisor is having with the corresponding client 106, provide recommended action 115 that the advisor should take for each conversation 270, allow the advisor to prepare a corresponding curation 116, and track any commitment 275 made by client 106. Sales pipeline 114 includes an interface generator 620 that generates an advisor dashboard 630 (e.g., an interactive interface screen of information) based upon data within sales pipeline 114 that is relevant to advisor 102. Advisor dashboard 630 may be displayed to advisor 102 via advisor application 290 and/or browser 294 and advisor 102 interacts with system 100 via advisor dashboard 630 to manage conversations 270, generate curations 116, and so on.

Sales pipeline 114, in cooperation with trigger module 206 and for each conversation 270, generates recommended action 115 that prompts advisor 102 in a next step of advising client 106. Advantageously, sales pipeline 114 and/or trigger module 206 takes into account many different factors, including a response time of client 106, a number of messages exchanged during conversation 270, activities of client 106 such as viewing products recommended in curation 116, adding items to a shopping cart, and so on.

Sales pipeline 114 and trigger module 206 cooperate to provide advisor 102 with at least one recommended action 115 for each conversation 270. For example, input from both advisor 102 and clients 106 may generate events 254 that are processed by trigger module 206 as described above and may result in one or more recommended actions 115 for each conversation 270. Recommended action 115 may be one of sending a message, making a product or service recommendation, snoozing a conversation, archiving a conversation, etc. Advisor 102 may view the context of each conversation within advisor dashboard 630 and may thereby learn why recommended action 115 is suggested, and may thereby determine what kind of message to send to client 106. For example, when client 106 views curation 116 without replying with feedback, trigger module 206 may generate a recommended action 115 for advisor 102 to follow up with the client.

Sales pipeline 114 includes a conversation ranker 610 that tracks quality and progress of each conversation 270, and collects data that allows each conversation to be steered towards a positive outcome based at least in part upon previous conversations. Conversation ranker 610 orders conversations 270 based upon recommended actions 115, and prompts advisor 102 to respond, and/or take other actions, at a most beneficial time in the conversation through advisor dashboard 630. For example, of leads 109, advisor dashboard 360 may indicate leads assigned advisor 602, leads needing curation 604, leads already having curation 606, and leads committed 608 towards a positive result. Advantageously, through advisor dashboard 630, advisor 102 may immediately see their current workload, the progress, and be prompted on how to respond to the more urgent conversations. Sales pipeline 114 allows advisor 102 to support and advise many clients 106 simultaneously. A further advantage of sales pipeline 114 is that clients 106 that take longer to respond are not forgotten. Particularly, since new leads are assigned to advisors 102 daily, existing, slow moving, conversations 270 could be forgotten. However, sales pipeline 114 automatically moves each current conversation 270 to a top of advisor dashboard 630 when an action or response to that conversation is due, and thus conversations are not accidently forgotten.

FIG. 7 is a block diagram illustrating advisor dashboard 630 of FIG. 6 in further example detail. As noted above, each advisor 102 may access advisor dashboard 630 via advisor application 290 and/or browser 294, each providing a similar interactive experience. Advisor dashboard 630 is divided into a plurality of display areas including an advisor activity summary 702, a sales pipeline summary 710, folders 720, a conversation list 730, a conversation thread 740, information sources 750, and request details 113. Advisor activity summary 702 and sales pipeline summary 710 correspond to a most recent period of activity, such as the last three months, and thereby allows advisor 102 to see his/her most recent activity and performance. Advisor activity summary 702, sales pipeline summary 710, and folders 720 each display a summary of multiple folders, created by sales pipeline 114, that may be selected by advisor 102 to display corresponding information.

Advisor activity summary 702 includes a “needs action” folder 704, showing a count of conversations 270 that are waiting for action by advisor 102, and an “active” folder 706, showing a count of all active conversations 270 assigned to advisor 102. Collectively, these displayed counts provide a workload summary of advisor 102.

When advisor 102 selects “needs action” folder 704, dashboard 630 displays conversation list 730 with an ordered, most urgent first, list of conversations 270 that are awaiting action by advisor 102. Particularly, items within “needs action” folder 704 may include an associated recommendation 115 such that advisor 102 may easily select and act on the more urgent conversations. When an item is then selected from conversation list 730, advisor dashboard 630 displays the full context of the selected conversation in conversation thread 740, information sources 750, and request details 113, such that advisor 102 has all relevant information accessible and may therefore resume the conversation effortlessly.

When advisor 102 selects active folder 706, dashboard 630 displays conversation list 730 with an ordered, most recent activity first, list of conversations 270 that are in progress (e.g., active) with advisor 102. Accordingly, active folder 706 may be conveniently used by advisor 102 to follow current conversation where the corresponding clients 106 are responsive (e.g., live conversations). Active folder 706 allows advisor 102 to find conversations that are not waiting for any action by advisor 102 (e.g., conversations that await a response from client 106). Conversations may be automatically archived after fourteen days of inactivity unless the conversation is starred or snoozed (see starred folder 722 and snoozed folder 724 described below).

Sales pipeline summary 710 includes folders that allow advisor 102 to see conversations 270 in various stages of sales pipeline 114. For example, sales pipeline 114 automatically progresses conversations based on the whether the client 106 is reviewing a curation 116 (e.g., has offer) or is yet to receive curation 116 (need offer), and also based on a length of the conversation (as an indication of quality of the conversation). Sales pipeline summary 710 has three folders: a “need offer” folder 712 that displays a count of conversations 270 with advisor 102 that are waiting for advisor 102 to provide a curation 116, a “has offer” folder 714 that displays a count of conversations 270 with advisor 102 that have received curation 116 but not responded positively or negatively, and a “sold” folder 716 that displays a count of conversations 270 with advisor 102 that have responded positively (e.g., made a purchased based upon curation 116). Each of these folders 712, 714, and 716, may also display a monetary value indicative of a sum of potential or actual sales revenue corresponding to each conversation in that folder, thereby providing advisor 102 with an indication of where conversations may be nurtured to result in positive outcomes with the greatest value.

Folders 720 allows advisor 102 to track conversations 270, and corresponding clients 106, independent of sales pipeline 114. For example, a starred folder 722 contains conversations flagged by advisor 102 as being of importance, thereby allowing advisor 102 to easily find important conversations in the future. For example, where advisor 102 has a strong relationship with a frequently returning client 106, advisor 102 may star these conversations such that they may be easily retrieved and referenced in future conversations with the same client, or retrieved and references to learn techniques used in successful conversations. Snoozed folder 724 stores conversations that advisor 102 has put on hold, whereby the conversation does not appear in the active folder 706 and system 100 does not generate actions or automatic prompts to keep the conversation current. When advisor 102 snoozes a conversation, advisor may specify a duration of the snooze period, or an end time/date of the snooze, whereby the conversation is automatically reactivated (e.g., moved from snoozed folder 724 to active folder 706) at the appropriate time. Optionally, a message may also be generated for the conversation at the end of the snooze period. For example, where advisor 102 learns that client 106 needs time to consider an offer, or learns that client 106 is away on business trip, advisor 102 may snooze the conversation to prevent unwanted prompts being sent to the client. Archived folder 726 may be used to store conversations 270 that are no longer active. For example, conversations that have had no activity for at least fourteen days (and do not appear in starred folder 722 or snoozed folder 724) may be automatically archived, but may be found by advisor 102 in archived folder 726. No replies folder 728 stores conversations where the corresponding client 106 has made no reply at all. These conversations are started for leads 109, wherein at least one message is sent to the provided contact information to initiate a conversation (e.g., inviting a client to interact with a path flow 110), but the client has not responded. Conversations with no reply from the client do not appear in any active folder 706; however, advisor 102 may find these conversations/leads in no replies folder 728, and may attempt to illicit interaction to engage the corresponding client 106.

Advisor 102 may select one of need offer folder 712, has offer folder 714, and sold folder 716 to display corresponding conversations in conversation list 730. In the example of FIG. 7, advisor 102 has selected has offer folder 714, and conversation list 730 displays corresponding conversations 270 of sales pipeline 114, as ordered by conversation ranker 610 such that advisor 102 sees the more urgent conversations at the top of conversation list 730. As shown in FIG. 7, conversation 270(2) also includes a recommended action 115(2). System 100 displays a selected conversation 270 in conversation thread 740. Advantageously, conversation thread 740 shows messages to and from client 106 irrespective of the communication channel used. Conversation thread 740 also displays recommended action 115 to prompts advisor 102 for the selected conversation.

Information sources 750 may include a plurality of pull-down panels that indicate provide a summary of the information available. In the example of FIG. 7, a first pull-down panel 752 indicates that curation 116 has four items, wherein selecting pull-down panel 752 displays the items (e.g., curation 116). A second pull-down panel 754 indicates that client 106 has places two items in an online shopping cart, and selecting second pull-down panel 754 displays these items. A third pull-down panel 756 allows advisor 102 to view any captured notes and pinned messages relating to conversation 270. A fourth pull-down, 758 is shown opened and displays lead details associated with conversation 270, and may include client online activity 759, such as products viewed online by client 106.

Request details 113 represents information captured by path module 202 using path flow 110 for example. This allows advisor 102 to see specific responses (selections and answers) made by client 106 during interaction with path flow 110, which may be useful to advisor 102 when providing advice to client 106.

Advisor dashboard 630 also includes an edit offer button 770 that, when selected by advisor 102, opens an interactive edit screen that allows advisor 102 to generate curation 116.

Advantageously, advisor dashboard 630 provides advisor 102 with all needed information for advising each client 106, responding to respective conversations 270, and recommended actions 115 for each conversation 270.

Trigger sequences 252 that generate recommended actions 115 may become more useful and context aware over time, since advisors 102 may generate their own rules for generating recommended actions 115 and/or automatically sending messages or curations 116. For example, advisor 102 may tag a created action, curation, and/or message for use in other scenarios and/or for use with different types of leads. Rules created by advisor 102 may be stored in a library such the other advisors 102 may view and use the best rules.

### Recommended by Other Advisors

Based, at least in part, upon curation 116, sales pipeline 114 and/or trigger module 206 may generate a recommendation 274 for client 106 that indicates where other advisors have provided a similar curation 116 to other clients. For example, where curation 116 recommends a particular brand and configuration of golf clubs for client 106, sales pipeline 114 may generate recommendation 274 to define advisors 102 that have recommended similar golf clubs to other clients 106. Unlike conventional retail websites that indicate what other clients view and/or purchase after looking at a product, sales pipeline 114 generates recommendation 274 to indicate where that product has been recommended by other advisors 102 to other clients 106. Accordingly, recommendation 274 builds confidence in curation 116 for client 106, thereby increasing likelihood of a positive outcome.

### Lead Ranking Algorithm

Prior to assigning each lead 109 to one advisor 102, and after invoking path module 202 to determine client intent 112, advisor interface system 100 may invoke lead ranking algorithm 208 to rank leads 109 in order of likeliness of a positive outcome. Accordingly, leads 109 that are more likely to have a positive outcome may have a higher value. For example, for a current lead 109, based upon request details 113 received in response to path flow 110, and/or client intent 112, lead ranking algorithm 208 may predict a likely outcome and value of lead 109 based upon previous outcomes and values of similar leads, path flow, and client intent 112 in historical data. That is, based upon a number of previously determined request details 113 and client intents 112 that match request details 113 and client intent 112 for a current lead 109 in the same category 107, lead ranking algorithm 208 may predict that the current lead 109 will have a similar outcome and therefore have a similar value. Accordingly, each new lead 109 may be ranked, and those predicted to have a more positive outcome may be given priority for assignment to one advisor 102. For example, historical data may indicate that a client in the golf category who is searching for a new driver is more likely to spend more money than a client in the golf category who is looking for a full set of clubs. Accordingly, the lead for the client searching for a new driver may have a higher ranking than the lead of the client searching for a full set of golf clubs.

After ranking new leads 109, advisor matcher 210 is invoked to assign these unassigned leads 109, in the ranking order (leads with the highest ranking—most likely positive outcome—first), to a most suitable advisor 102. Advisor matcher 210 uses machine learning, neural networks, and/or other types of artificial intelligence (AI) to match a given lead 109 (i.e., the corresponding client 106) with one advisor 102 that is most likely to provide client 106 with the most relevant advice and/or service recommendations. Matching advisors with leads is not as simple as assigning the highest-ranking lead to the highest-ranking advisor. Advisor matcher 210 may use category 107 defined by lead 109, client information (e.g., client characteristics 111, client intent 112, and/or request details 113), and advisor information (e.g., advisor characteristics 424, past performance—ratio of positive/negative outcomes, quality of conversations, advisor schedule 426, advisor rank 428 and workload 430). Advisor matcher 210 may also process conversations 270 associated with advisor 102 for the identified category 107 to determine a conversation quality 271 and a content level 273 of the conversations 270. Advisor matcher 210 may then uses the conversation quality 271 and content level 273 when matching lead 109 to advisor 102. For example, where conversations 270 of advisor 102 have high technical content (e.g., high content level 273), advisor 102 may be more suitably assigned to leads 109 with corresponding client characteristics 111, client intent 112 and/or request details 113 that indicate client 106 is looking for technical information. Conversely, where conversations 270 of advisor 102 have limited technical content, advisor 102 may be more suitably assigned to leads 109 with corresponding client characteristics 111, client intent 112 and/or request details 113 that indicate client 106 has no interest in technical data.

In certain embodiments, where client 106 is identified as having previously used system 100, advisor matcher 210 may analyze previous conversations of client 106 to better determine client intent 112. Where the previously assigned advisor resulted in a successful outcome with client 106, the same advisor may be assigned again; however, where the previously assigned advisor did not result in a successful outcome, an alternative advisor may be assigned.

Accordingly, the ability of advisor 102 to handle new lead 109 is also evaluated based upon past performance (e.g., from historical data) of the advisor's handling of similar leads, considering request details 113, client intent 112, client characteristics 111, and so on. For example, one advisor 102 who gets more positive results when helping inexperienced clients is more likely to be assigned to a new lead 109 for a client 106 who is inexperienced.

System 100 thereby takes other nuances into account when ranking and assigning leads 109 to ranked advisors 102. For example, in the golf category 107, the number of positive results from conversations 270 increases when clients 106 believe they are talking with an advisor who has a similar ability level. That is, a client who is a scratch golfer prefers to receive advice from an advisor who is also a scratch golfer. Similarly, a client who is an average golfer prefers to receive advice from an advisor wo is also an average golfer. However, this is not the case for other categories 107. In the winter sports category, more positive outcomes are achieved when the client receives advice from an advisor that skis/board at locations used by the client.

### Advisor Matching

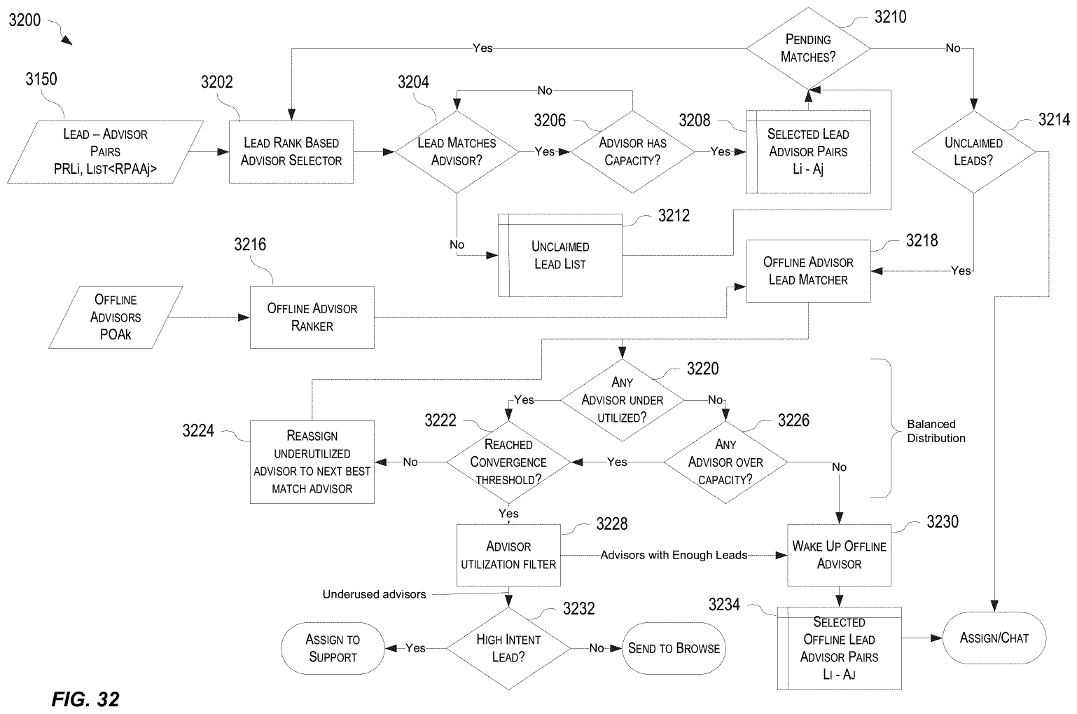

FIGS. 31 and 32 show further example detail of advisor—lead matching. FIG. 31 is a schematic illustrating example lead—advisor matching and assignment within system 100 of FIG. 1. FIGS. 31 and 32 are best viewed together with the following description. FIG. 31 represents a snapshot of system 100, where a number ‘n’ of leads 109 (labeled 109(1), 109(2)-109(n) are active in system 100 and are awaiting assignment to an available advisor 102. For each lead 109 shown in FIG. 31, the corresponding client 106 has completed an appropriate path flow 110 to generate request details 113. For example, client 106 has interacted, using web interface 264, with a path flow 110 corresponding to a category of a product or service they are interested in. Request details 113 stores answers to the questions within the path flow 110 and may store behavior of client 106 on the web interface.

In the example of FIG. 31, lead ranking algorithm 208 is shown implementing a lead ranker 3120 and a lead persona identifier 3122, and advisor matcher 210 is shown implementing an advisor persona identifier 3126, an engagement capacity filter 3128, a matcher 3130, and an assigner 3140.

Lead ranker 3120 processes at least request details 113 corresponding to each lead 109 to determine a ranking of the lead, and a lead persona ID 3122 processes request details 113 and output from lead ranker 3120 to segment each lead 109 into certain personas. For example, for each lead 109, lead ranker 3120 determines a probability of the corresponding client 106 having a positive result (e.g., a sale of a product to the client). Leads 109 are then ranked, based at least in part upon these probabilities. Particularly, a client 106 corresponding to a lead 109 determined to have a high intent of making a purchase may receive a more preferential treatment, as compared to a client corresponding to a lead determined as having a low intent. More preferential treatment includes giving priority to assignment of the lead 109 to a best available advisor 102 before a lower ranked lead is assigned. Output of lead ranker 3120 is a list of ranked leads that may be denoted as RLᵢ⇒{i∈1, 2, . . . n}.

For each lead 109, lead persona identification 3122 may process request details 113 to determine personality traits of client 106. Identified personality traits may include one or more of skill level, demographics, thrifty, deal seeker, loyal/return user, determined shopper—always wants the best, impatient, brand loyalist, sarcastic, mentor, and so on. Thus, for each new lead 109, lead persona identification 3122 may be based upon interaction of client 106 with web interface 264, and, within system 100, client 106 may be tagged with these determined personality traits. Output from lead persona identifier 3122 may be denoted as Personified Ranked Lead—PRLᵢ⇒{i∈1, 2, . . . n}.

Advisor persona identifier 3126 determines personality traits of each advisor 102 registered with system 100. Initially, advisor persona identifier 3126 determines personality traits of advisor 102 based upon one or more of a personality test, product specific questions in an advisor application form. Over time, advisor persona identifier 3126 may determine personality traits of advisor 102 based upon analysis of conversations between advisor 102 and multiple clients 106. For example, advisor persona identifier 3126 may use natural language processing to infer additional personality traits from conversations between advisor 102 and multiple clients 106. Within system 100, each advisor 102 may be tagged with these determined personality traits. Output from advisor persona identifier 3126 may be denoted as Personified Advisor—PAⱼ⇒{j∈1, 2, . . . m}.

Each advisor 102 has an optimal number of leads that they can concurrently handle. This number is very personal to the advisor and may depend on one or more of the advisor's style of engaging in conversations with leads, the advisor's style of selling, the number of hours the advisor is actively logged into system 100, and the responsiveness of the clients that they are conversing with.

In certain embodiments, engagement of advisor 102 is based on the notion of an activity time window, and may not be based upon a number of leads assigned to the advisor. A conversation between one advisor 102 and one client 106 may last over several hours, days or weeks, but conversations typically have bursts of activity followed by periods of inactivity. Where an advisor 102 converses with a client 106 who has long periods of inactivity, the advisor 102 may engage with a new lead during those periods. Engagement capacity filter 3128 filters out advisors 102 that are online with system 100 but that do not have the capacity (e.g., that are already over their optimal engagement capacity) to accept new leads. The output of engagement capacity filter 3128 may be denoted as Personified Available Advisors—PAAⱼ⇒{j∈1, 2, . . . m}. Engagement capacity filter 3128 may also generate a list of advisors that are not online with system 100, denoted as Personified Offline Advisors—POAk in FIG. 31.

Matcher 3130 inputs the PRLᵢ from lead persona ID 3122 and PAAⱼ from engagement capacity filter 3128 and, for each lead 109, provides a ranked list of advisors 102 that are candidate assignments to that lead. Advisor 102 are ranked in order of their closeness to lead 109. For example, closeness of an advisor to a lead may be based upon a combination of lead and advisor persona, conversation probability, and advisor ranking. Matcher 3130 generates a list of leads (PRLi), where each lead has a list of Ranked (closest) Personified Available Advisors (RPAAj):

PRLᵢ←→List<RPAAⱼ>{i∈1,2 . . . n && j∈1,2 . . . m} and m≤n

Assigner 3140 processes list of leads PRLi, each with its list of closes available advisors RPAAj to generate lead-available advisor pairs 3150 (Li, AAj), and may also generate a lead-unavailable advisor pairs 3152, and a list of unassigned leads 3154 (Li), as described below and shown in FIG. 32.

FIG. 32 is a flowchart illustrating one example greedy assignment algorithm 3200 for lead advisor assignment. Greedy assignment algorithm 3200 is implemented in assigner 3140 of FIG. 31, for example. One objective of greedy assignment algorithm 3200 is to maximize capacity of each advisor 102. Another objective of greedy assignment algorithm 3200 is to service as many leads 109 as possible.

In block 3202, algorithm 3200 inputs lead-advisor pairs for processing, and iteratively selects each lead and associated advisor list. In one example of block 3202, assigner 3140 receives PRLi, List<RPAAj> from matcher 3130, selecting PRL1 and list <RPAA1> in a first iteration. Block 3204 is a decision. If, in block 3204, algorithm 3200 determines that the selected lead matches the advisor, algorithm 3200 continues with block 3206; otherwise, algorithm 3200 continues with block 3212. Block 3206 is a decision. If, in block 3206, algorithm 3200 determines that the matched advisor has capacity, algorithm 3200 continues with block 3208. In block 3208, algorithm 3200 adds the matched lead and advisor to a list of matched lead and advisor pairs. In one example of block 3208, lead Li and advisor Aj are added to a temporary list of matched pairs. Block 3210 is a decision. If, in block 3210, algorithm 3200 determines that there are more leads to match, algorithm 3200 continues with block 3202; otherwise, algorithm 3200 continues with block 3214.

When none of the advisors listed for a lead are available to accept the lead, algorithm 3200 continues from block 3204 to block 3212 where algorithm 3200 adds the lead to an unclaimed lead list. Accordingly, algorithm 3200 builds a list of selected lead-advisor pairs (block 3208) and builds a list of unclaimed leads (block 3212). When there are no more new leads to assign, algorithm 3200 continues from block 3210 to block 3214.

Accordingly, a “happy path’ through algorithm 3200 occurs when, for each new lead 109 received in block 3202, the top matched advisor 102 has capacity to access the lead. Thus, blocks 3202 through 3210 implement a first assignment strategy. Since algorithm 3200 is greedy, the success probabilities of assignments are ignored and each matched lead 109 is greedily assigned to the highest ordered available advisor 102.

Block 3214 is a decision. If, in block 3214, algorithm 3200 determines that there is at least one unclaimed lead in the unclaimed lead list (block 3212), algorithm 3200 continues with block 3218; otherwise, algorithm 3200 assigns the leads to the advisors 102 and/or initiates chats with between the corresponding clients 106 and assigned advisors 102.

A second assignment strategy is implemented to match any lead 109 not matched by the first assignment strategy (e.g., blocks 3202 through 3210) to one advisor 102 that, although not currently online with system 100, may be activated. In block 3218, algorithm 3200 matches offline advisors, determined as POAk by engagement capacity filter 2128 and input in block 3216, to each lead in the unclaimed lead list created by block 3212. An offline advisor may be activated (e.g., by sending a text and/or email) with a certain probability, which may be learned by system 100. Accordingly, block 3218 may include functionality similar to blocks 3202 through 3210, but operates to assign advisors from list POAk to each lead of the unclaimed lead list of block 3212. Each offline advisor 102 may have a threshold (e.g., 5) that defines a minimum number of assigned leads that result in activation of that offline advisor. That is, when the offline advisor is assigned too few leads, the advisor is not activated. This prevent the offline advisor from being activated too eagerly without sufficient reason.

In blocks 3220 through 3226, algorithm 3200 balances distribution of the unclaimed leads to the offline advisors. For example, unclaimed leads of an advisor with too many leads (e.g., exceeding capacity of the advisor) may be distributed to offline advisors that do not have sufficient leads to be activated. Block 3220 is a decision. If, in block 3220, algorithm 3200 determines that the advisor is underutilized, algorithm 3200 continues with block 3222; otherwise algorithm 3200 continues with block 3226. Block 3226 is a decision. If, in block 3226, algorithm 3200 determines that any advisor is over capacity, algorithm 3200 continues with block 3222; otherwise algorithm 320 continues with block 3230. In block 3230, algorithm 3200 activates the offline advisor and forms a list of selected offline lead-advisor pairs (li-Aj) in block 3234. In one example of block 3230, system 100 sends one or more of a notification, text, email, and voice call to offline advisor 102 indicating that new leads are waiting online. System 100 then processes the selected offline lead-advisor pairs of block 3234 and the leads 109 are assigned to the advisors 102 and/or chats between the advisor 102 and the client 106 corresponding to the lead 109 are initiated.

Block 3222 is a decision. If, in block 3222, algorithm 3200 determines that a convergence threshold has been reached, algorithm 3200 continues with block 3228; otherwise algorithm 3200 continues with block 3224. In block 3224, algorithm 3200 reassigns underutilized advisors to next best match advisor. In one example of block 3224, unclaimed leads 109 of an offline advisor 102 that has too few leads to be activated are reassigned to a next best matched offline advisor, and unclaimed leads 109 that exceed an offline advisor 102 capacity are reassigned to a next best advisor. The convergence threshold of block 3222 prevents a cyclic effect of continually reassigning leads between offline advisors. For example, the convergence threshold may limit the number of iterations that may be performed by blocks 3220 through 3226 to balance distribution of unclaimed leads to offline advisors. Accordingly, blocks 3220 through 3226 iterate over an assignment to optimize assigning multiple leads to a single offline advisor to stay within the lower and upper capacity threshold.

In block 3228, algorithm 3200 processes the unclaimed lead—offline advisor matches, continuing with block 3230 for offline advisors that have enough leads to be activated, and continuing with block 3232 for advisors that are underused (e.g., where the number of leads matched to the advisor is below the advisor's activation threshold). Accordingly, blocks 3230 and 3234 activate the advisor 102 and initiates handling to the assigned leads. For underused advisors, block 3232 is a decision. If, in block 3232, algorithm 3200 determines that the unclaimed leads of the offline advisor have a high intent level, algorithm 3200 assigns the lead to support staff; otherwise, algorithm 3200 sends the client corresponding to the lead 109 with lower intent to browse further information. For example, a higher intent lead 109 may trigger an alert for a support agent (e.g., a Delegate expert or an Assistant) to manually assign the lead 109 to an agent 102.

### Automated Advisor Recruitment

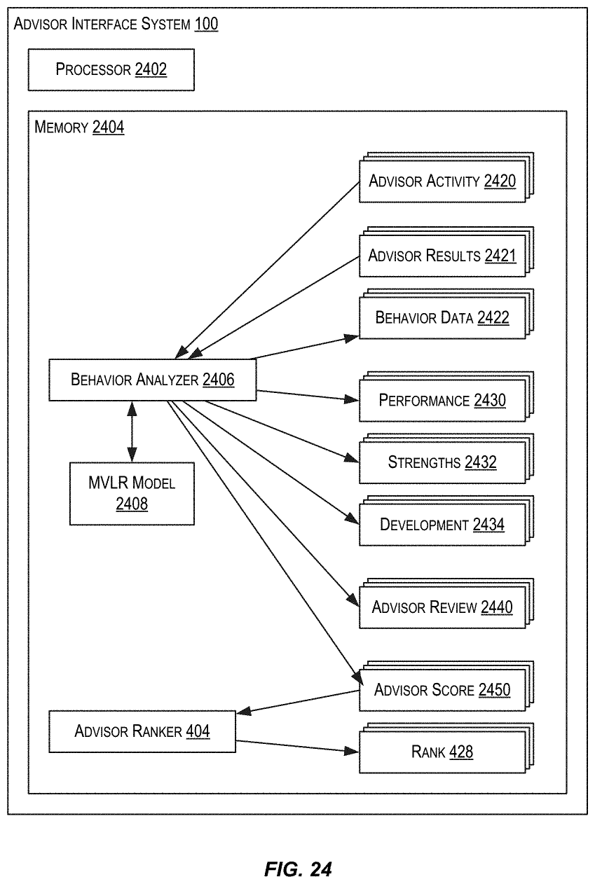

System 100 relies upon advisors 102 to provide advice to, and to meet the needs of, clients 106. Workload optimizer 204 automatically purchases sufficient new leads 109 to provide work for available advisors 102, automatically tailoring supply of new leads 109 to advisor capability, workload capacity, experiences, and so on. However, for system 100 to grow in size, system 100 may recruit new advisors 102 based upon referrals and interest of the potential advisor. A person wishing to become an advisor in one or more categories 107 may apply through an advisor recruiting web site (e.g., implemented by web interface 264). System 100 then invokes at least one experienced advisor in the same category to virtually screen and activate, when the new advisor meets certain criteria, the new advisor by creating a new account (e.g., with unique contact number 265 and email address 267) so that the new advisor may start receiving leads. System 100 invokes, at intervals, advisor ranker 404 to rank advisors 102 (e.g., one of platinum, gold, silver, and bronze, where platinum is highest and bronze is lowest) based upon performance (e.g., historical revenue per assigned lead). Ranking may determine shift prioritization and when the advisor receives additional leads. Rank 428 is determined by calculating a score for each advisor based at least in part upon success of advisor 102 in converting each assigned lead 109 into a successful result (e.g., a sale based upon the provided curation 116). FIG. 24 and associated description provides further details on score calculation.

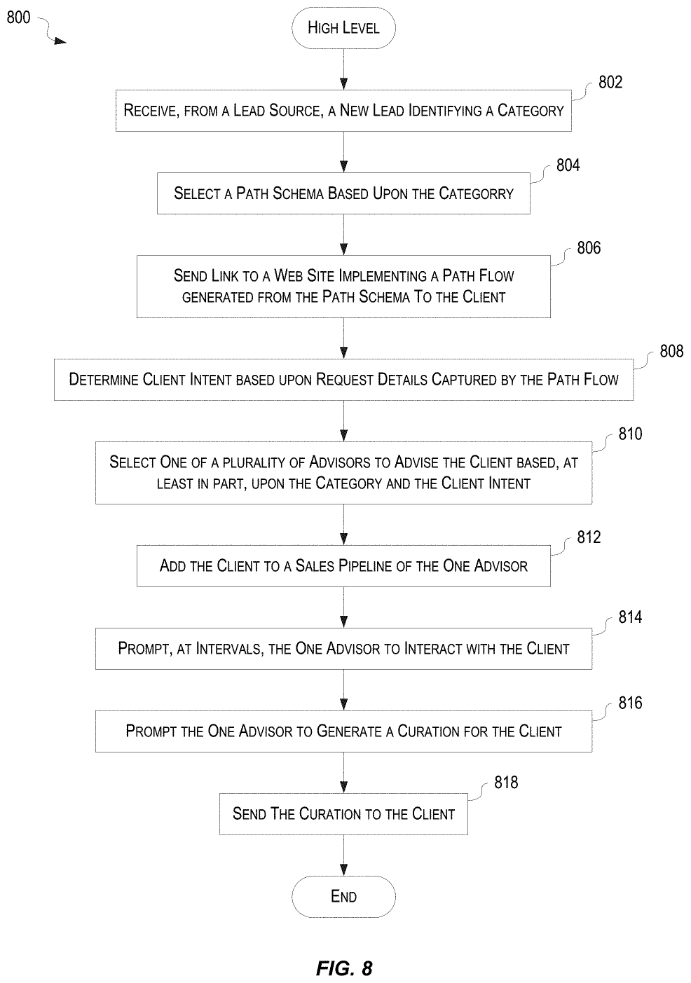

FIG. 8 is a flowchart illustrating one example method 800 for managing interaction between one of a plurality of advisors 102 and client 106. Method 800 is, for example, implemented within at least one of sales pipeline 114, path module 202, workload optimizer 204, trigger module 206, lead ranking algorithm 208, advisor matcher 210, distributed queue manager 212, and multi-channel communications 214.

In block 802, method 800 receives, from a lead source, a new lead defining a category. In one example of block 802, path module 202 receives, from lead generator 108, new lead 109 identifying one of categories 170. In block 804, method 800 selects a path schema based upon the identified category. In one example of block 804, path module 202 selects path schema 308 from path database 203 based upon at least category 107. In block 806, method 800 sends, using the contact information, a link to a web site implementing a path flow generated from the path schema to the client. In one example of block 806, path module 202 sends a URL to a web site implemented by web interface 264 to client 106. In block 808, method 800 determines client intent based upon request details captured by the path flow. In one example of block 808, path module 202 receives request details 113 derived from interaction of client 106 with path flow 110 on web interface 264 and then invokes classifier 310 to determine client intent 112 from request details 113.

In block 810, method 800 selects one of a plurality of advisors to advise the client based, at least in part, upon the category and the client intent. In one example of block 810, advisor matcher 210 matches advisor information 242 of advisor database 240 to the identified category 107 of new lead 109 and corresponding client intent 112 to select advisor 102 to advise client 106. In block 812, method 800 adds the client to a sales pipeline of the one advisor. In one example of block 812, advisor matcher 210 adds a conversation 270, identifying client 106 and with a recommended action 115 to start a conversation, to sales pipeline 114 of advisor 102. In block 814, method 800 prompts, at intervals, the one advisor to interact with the client. In one example of block 814, trigger module 206 generates at least one recommended action 115 for conversation 270 based upon events 254 corresponding to conversation 270. In block 816, method 800 prompts the one advisor to generate a curation for the client. In one example of block 816, trigger module 206, in response to one or more events 254 and/or a determined conversation quality 271, adds recommended action 115 to conversation 270 to recommend that advisor 102 generates curation 116 for client 106. In block 818, method 800 sends the curation to the client. In one example of block 818, multi-channel communications 214 sends curation 116 to client 106 using one or more of application interface 262, web interface 264, SMS interface 266, and email interface 268.

### Templates

System 100 may allow each advisor 102 to save messages and curations as templates such that they may be reused. Advisor 102 may name each message template, making it easier to select the appropriate message template when creating a new message. Advisor 102 may name each curation template, making it easier to select the appropriate curation template when creating a new curation 116. These templates are stored by system 100 and may be displayed to advisor 102 in a corresponding message template list and curation template list. Advisor 102 may select a message template from a message template list when creating a new message to start a new conversation or when replying to a message from client 106 in an existing conversation. Similarly, advisor 102 may select a curation template from a curation template list when creating a new curation 116. An example curation template list includes: “Skilled player Irons and Drivers,” “Game Improver Irons and Drivers,” “Top Wedges,” “B+ bikes,” and “Full beginner box sets.”

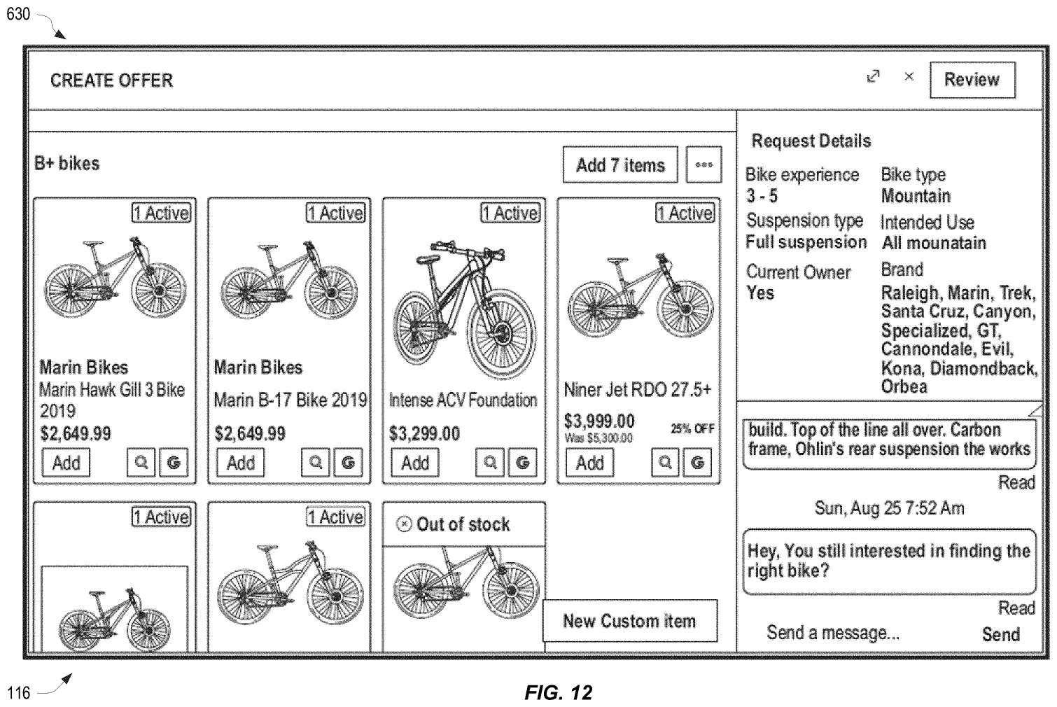

FIG. 12 shows part of advisor dashboard 630 with an example curation 116 generated from a curation template (e.g., labeled “B+ bikes”). In this example, a current conversation 270, client intent 112, and request details 113 indicate that client 106 is an experienced mountain biker in need of a new bike, and therefore advisor 102 selects curation template labeled “B+ bikes” when creating curation 116 for client 106. Advisor 102 may further customize the generated curation 116 before sending it to client 106. Each curation template may be based upon products the advisor often recommends (e.g., common client requests or advisor personal favorites).

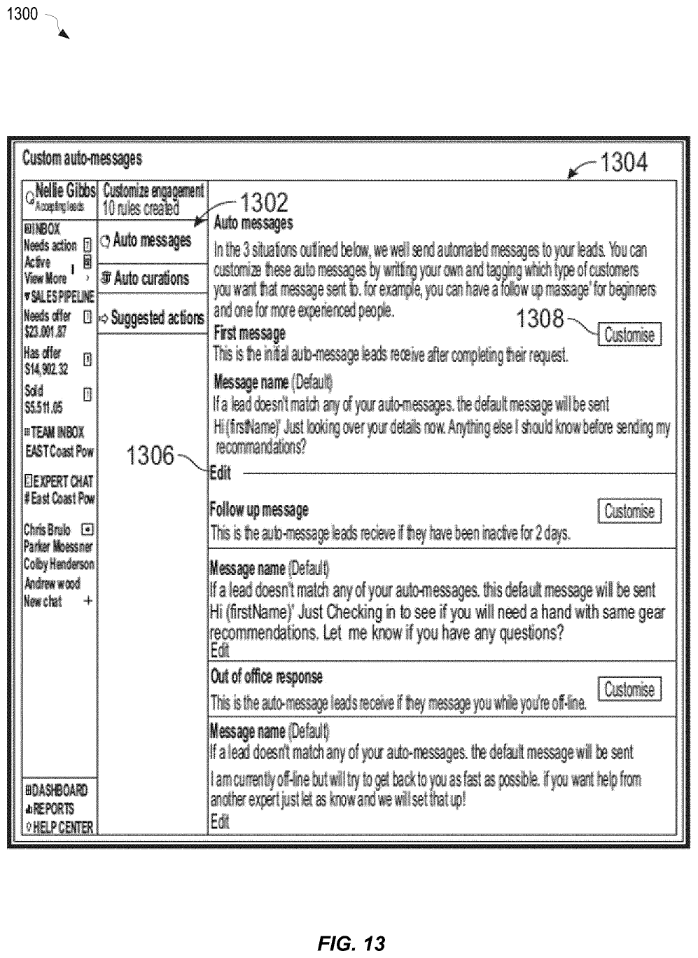

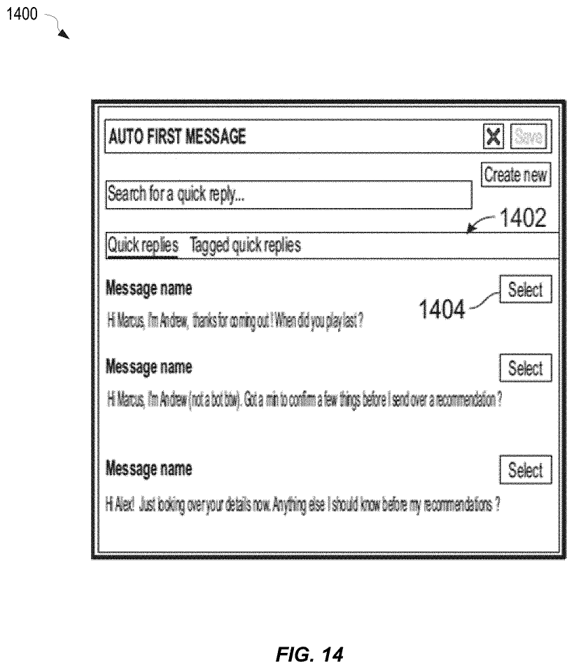

FIG. 13 shows one example screenshot 1300 for customizing automatic messages within system 100. In screenshot 1300, advisor 102 has selected an auto messages tab 1302 to display an auto message category list 1304, including a first message, a follow up message, and an out of office response message. Advisor 102 may edit defaults message texts for each category by selecting a corresponding edit button 1306. Advisor 102 may also select a customize button 1308 to create or edit customized messages for each category. FIG. 14 shows one example dialog window 1400, opened in response to advisor 102 selecting customize button 1308, displaying a list 1402 of customized automatic first messages. Each listed message has a corresponding select button 1404, which may be selected by advisor 102 to define context of the custom message.

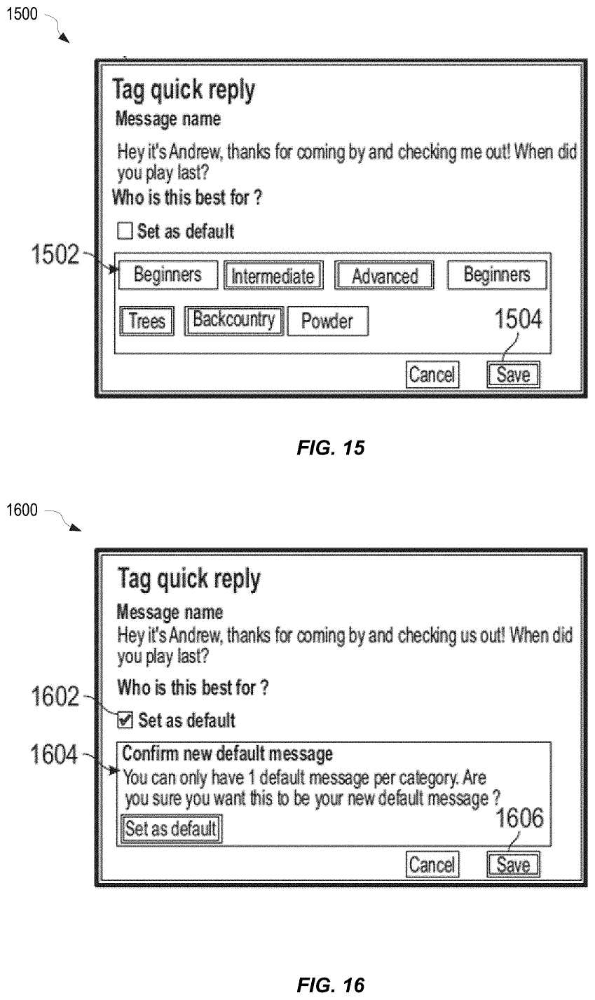

FIG. 15 shows one example tag quick reply dialog window 1500, which opens when advisor 102 selects select button 1404 of dialog window 1400 to define context for the corresponding message template. Advisor 102 may define one or more context settings for each message template. In the example of FIG. 15, advisor 102 may indicate who the message template is best used for by selected at least one experience level 1502 for the message template. System 100 may automatically send a message to client 106 based upon the message template when client 106 matches the defined context (e.g., experience level). Contexts may include “time since last response,” “budget,” and so on. For example, advisor 102 may configure system 100 to automatically send a follow up message to any client 106 that has not responded in a conversation for a defined period (e.g., more than three days) and that has defined a budget under $500. To implement this, advisor 102 defines a context of a corresponding message template with a no response period of three days and “budget under $500.” Advisor 102 may create a different message template for clients 106 who have not responded but have higher budgets. Alternatively, advisor 102 may not create a template for clients with high budgets, such that system 100 does not automatically send follow-up messages to those clients. This would allow advisor 102 to take a high touch approach with such clients when prompted by system 100.

FIG. 16 shows one example tag quick reply dialog window 1600 where advisor 102 has selected a “set as default” check-box 1602 to indicate that the template should be used as the default message for a particular category 107. Advisor 102 may confirm 1604 that the default message should be replaced to enable the save button 1606, which, when selected, causes the message template to be used as the default message for that category 107.

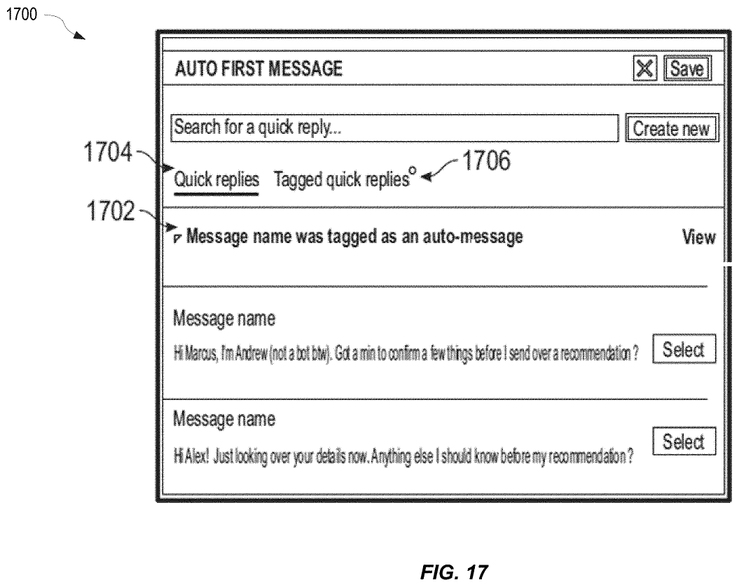

FIG. 17 shows one example dialog 1700 showing a list 1702 of saved messages templates under a quick replies tab 1702, and a badged tagged quick replies tab 1706 indicating that the saved message template has a defined context for automatic use.

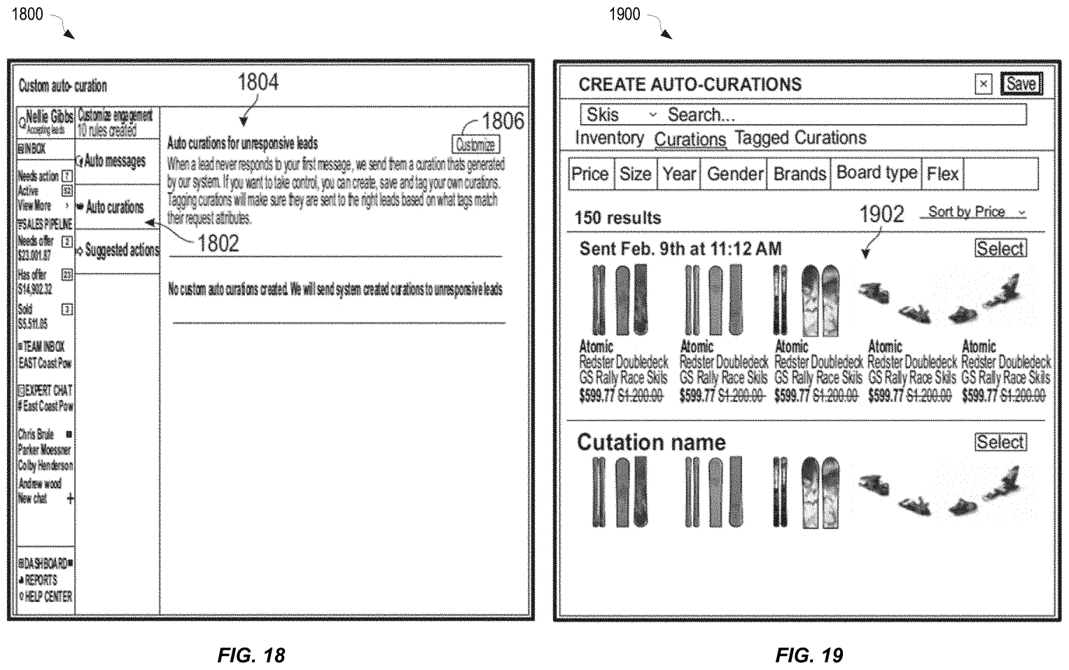

In addition to saving templated messages for use in specific contexts, advisor 102 may also customize a curation template for automatic selection and delivery to client 106 when client 106 is unresponsive (e.g., when client 106 would prefer not to start conversation 270). FIG. 18 shows one example dashboard 1800 where selection of an “auto curations” tab 1802 displays a list 1804 of auto curations for unresponsive leads. FIG. 19 shows one example dialog window 1900 that is displayed when the advisor 102 selects a customize button 1806 of list 1804 of FIG. 18. Dialog window 1900 shows a list 1902 of curation templates, and advisor 102 may select one curation to add context (e.g., tagging) for automatic selection by system 100.

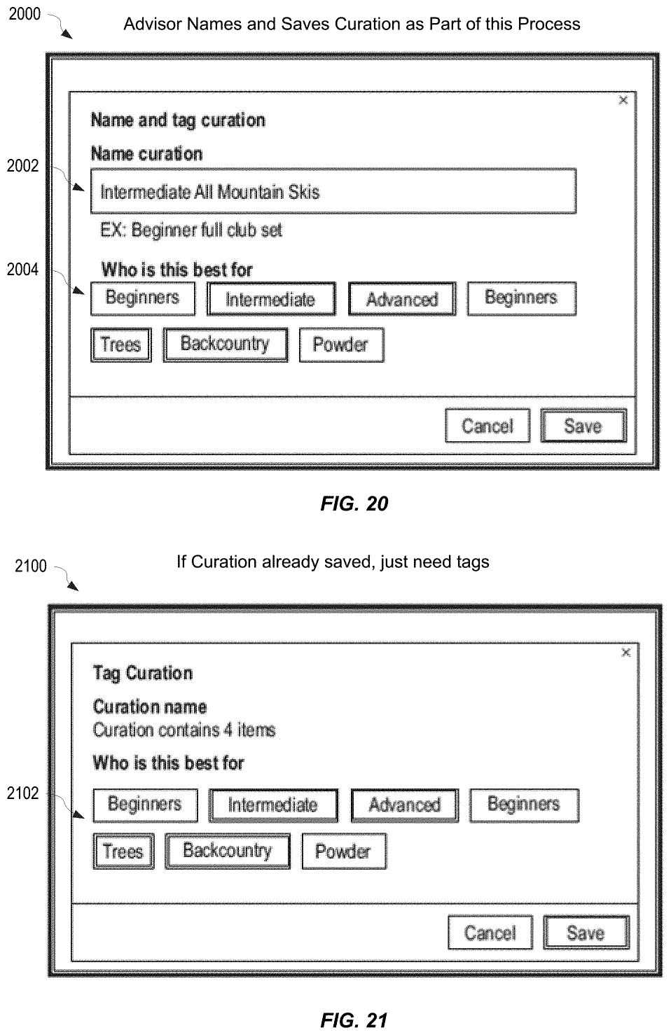

FIG. 20 shows one example tag curation dialog window 2000 that allows advisor 102 to name 2002 the curation template and define an experience context 2004 (e.g., client experience level) for the curation template. FIG. 21 shows one example tag curation dialog window 2100, displayed for a curation template that is already saved, allowing advisor 102 to define experience context 2102.

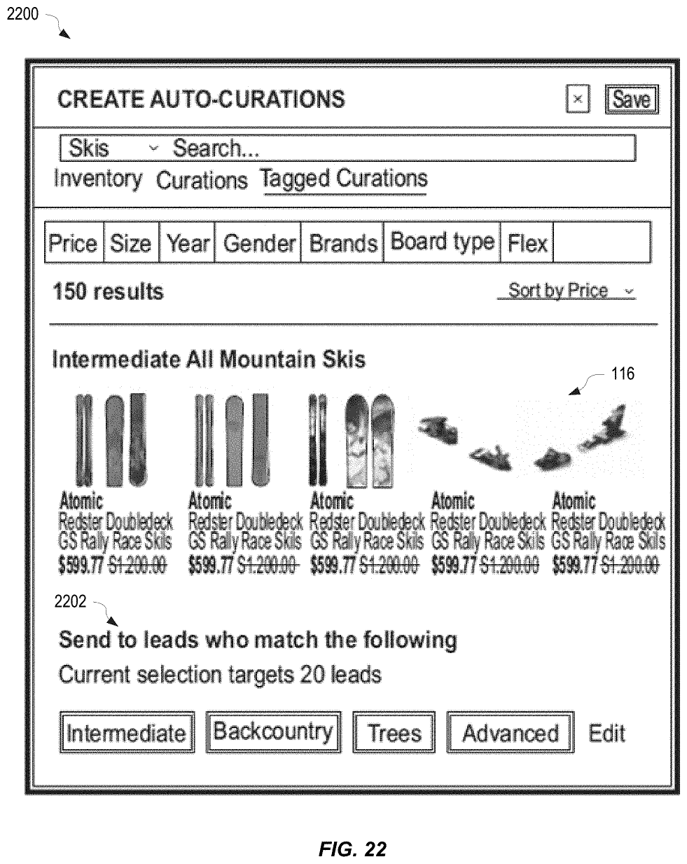

FIG. 22 shows one example curation template display 2200 for a previously saved curation template, showing context 2202 that is matched to clients 106 for automatic use of the saved curation 116.

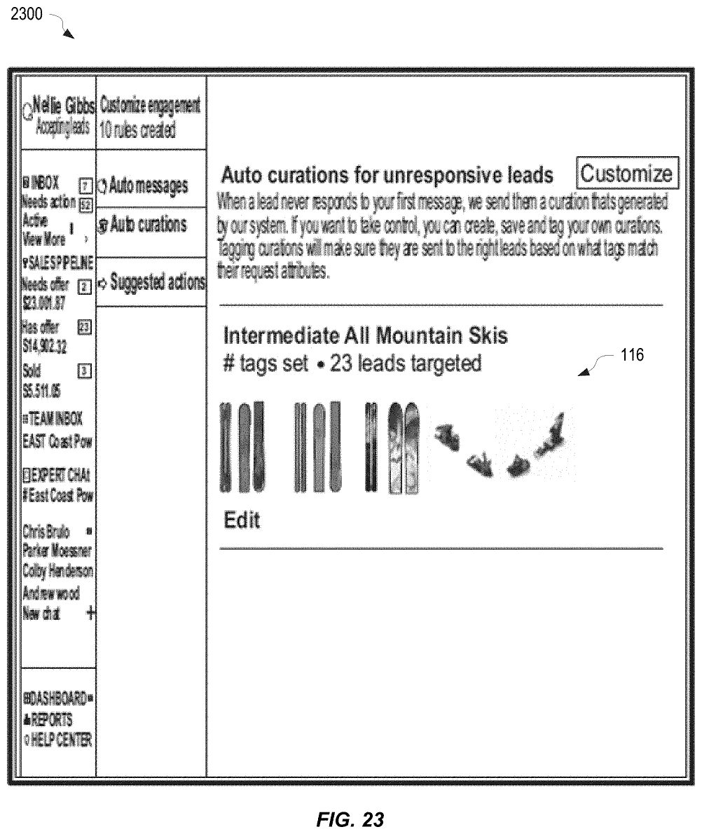

FIG. 23 show one example dashboard 2300 showing an auto curation 116 that may be sent to clients 106 that are unresponsive and have client intent 112 and/or request details 113 that indicate an interest in intermediate all mountain skis.

### Identifying Successful Advisor Behavior

Certain advisors 102 may be more successful than others. For example, one advisor 102 may, through conversational style and timing of recommendations, imbue confidence in clients 106 more successfully that another advisor 102 who may appear too “pushy” by providing curation 116 too soon during a conversation discussing requirements of client 102. Accordingly, certain actions and conversational techniques may be identified by system 100 as being more successful than others. System 100 may also determine, for unsuccessful conversations between advisors 102 and clients 106, when recommendations are provided too soon, or too late, during the conversations.

FIG. 24 shows advisor interface system 100 with a processor 2402 communicatively coupled with a memory 2404 that includes a behavior analyzer 2406, implemented as machine-readable instructions (e.g., software) executable by processor 2402, and a multivariate linear regression (MVLR) model 2408. In this example, advisor activity 2420 may include, for each advisor 102 and for each conversation 270, activity and actions performed by advisor 102 and/or client 106. For each category 107, behavior analyzer 2406 may use MVLR model 2408 to process advisor activity 2420 and/or advisor results 2421 to determine which behaviors matter most to the success of advisor 102, and may generate and store the determined behaviors as behavior data 2422.

Behavior analyzer 2406, using MVLR model 2408, may determine behavior characteristics including one or more of: snoozes per active lead, quick replies used per active lead, stars per active lead, archives per active lead, profile completeness, out of shift messages percent, curated orders per active lead, curated items per active lead, active leads with curated orders, active leads with curated items, active leads with custom curated items, active leads with curated items with notes, calls per active lead, inactive leads messaged, notes authored per curated item sent, curated items added to cart, curated items with tags, curated items with custom price, percent of active leads within sla, image message percentage, video message percentage, file message percentage, questions asked, price mentions, message length, pauses per shift, message sentiment, early message sentiment, late message sentiment, early questions asked, late questions asked, early price mentions, late price mentions, early message length, late message length, and expert to user message ratio.

Snoozes per active lead is the percentage of active leads that advisor 102 has snoozed at any point in time. Quick replies used per active lead is the number of quick reply messages sent/the number of active leads. For example, advisor 102 may create templated messages that they may later use as quick replies to efficiently send common messages. Stars per active lead is the percentage of active leads that advisor 102 has starred at any point in time. Archives per active lead is the percentage of active leads that advisor 102 has archived at any point in time. Profile completeness is a score between 0 and 1 that represents how many fields are filled in on a profile of advisor 102. Out of shift messages percent is the percentage of messages that advisor 102 sent while not accepting new leads (not including pauses). Curated orders per active lead is an average number of experience (ex. Yacht Charters) recommendations per active lead by advisor 102. Curated items per active lead is an average number of product (e.g., Golf Club) recommendations per active lead of advisor 102. Active leads with curated orders is the percentage of active leads that has received an experience recommendation from advisor 102. Active leads with curated items is the percentage of active leads that have received a product recommendation from advisor 102. Active leads with custom curated items is the percentage of active leads that have received a custom offer. Active leads with curated items with notes is the percentage of active leads that have received a product recommendation with advisor notes. Calls per active lead is the percentage of active leads that have had a phone call with advisor 102. Inactive leads messaged is the percentage of active leads that have received a custom offer. Notes authored per curated item sent is the percentage of inactive leads advisor 102 has messaged (i.e. advisor 102 sent client 106 a manual message without client 106 ever sending a message). Curated items added to cart is the percentage of product recommendations that advisor 102 added directly to the cart of client 106. Curated items with tags is the percentage of product recommendations with tags (i.e. “Expert Pick,” “Special Offer,” “The Alternative”). Curated items with custom price is the percentage of product recommendations for which advisor 102 manually updated the price. Percent of active leads within sla is the percentage of active leads for which advisor 102 responded to the first message of client 106 within 1 minute. Image message percentage is the percentage of messages from advisor 102 where the message body was an image. Video message percentage is the percentage of messages sent by advisor 102 where the message body was a video. File message percentage is the percentage of messages sent by advisor 102 where the message body was a file (e.g., a voice recording). Questions asked is the percentage of messages send by advisor 102 containing a question. Price mentions is the percentage of messages send by advisor 102 referencing price. For example, this may include messages confirming budget, price matching, talking about discounts, etc. Message length is the average length of messages send by advisor 102. Pauses per shift is the average number of times advisor 102 pauses per shift. Message sentiment is the average sentiment of messages send by advisor 102. For example, messages with positive sentiment contain happy, friendly, etc. words that convey a positive emotion; the greater the number of happy words, the higher the message sentiment score. Early message sentiment is the average sentiment of the first 5 messages sent by advisor 102 to client 106. Late message sentiment is the average sentiment of messages, after the first 5, sent by advisor 102. Early questions asked is the percentage of the first 5 messages sent by advisor 102 containing a question. Late questions asked is the percentage of messages, after the first 5, sent by advisor 102 containing a question. Early price mentions is the percentage of the first 5 messages sent by advisor 102 referencing price. For example, this may include messages confirming budget, price matching, talking about discounts, etc. Late price mentions is the percentage of messages, after the first 5, sent by advisor 102 referencing price. For example, this may include messages confirming budget, price matching, talking about discounts, etc. Early message length is the average length of the first 5 messages sent by advisor 102. Late message length is the average length of messages, after the first 5, sent by advisor 102. Expert to user message ratio is the number of messages sent by advisor 102/the number of messages send by client 106. Advisor 102 may send more messages than client 106. For example, at the high end, advisor 102 sends on average 1.6 messages for every message sent by client 106.

MVLR model 2408 is trained to identify behavior of advisors 102 that corresponds to success (higher conversion rate of clients 106 making purchases based upon curations 116) for advisor 102. For each advisor 102, MVLR model 2408 may generate performance 2430 that indicates an overall performance of advisor 102 within system 100, strengths 2432 that indicate behavior of advisor 102 that is strong, and development 2434 that indicates behavior of advisor 102 that may benefit from further effort to improve performance 2430.

MVLR model 2408 calculates an advisor score 2450 based, at least in part, upon one or more of advisor activity 2420, advisor results 2421, and behavior data 2422. Advisor score 2450 is not only based upon results, since MVLR model 2408 takes into account behavior of advisor 102, quality of leads 109, category 107, and so on. Accordingly, advisor score 2450 is an accurate evaluation of advisor 102 and may be used to compare advisor 102 against peers. As described above, advisor ranker 404 may process advisor scores 2450 to generate rank 428 for each advisor 102. Rank 428 thereby accurately defines expected capability of advisor 102 as used to control capacity of system 100, as described above.

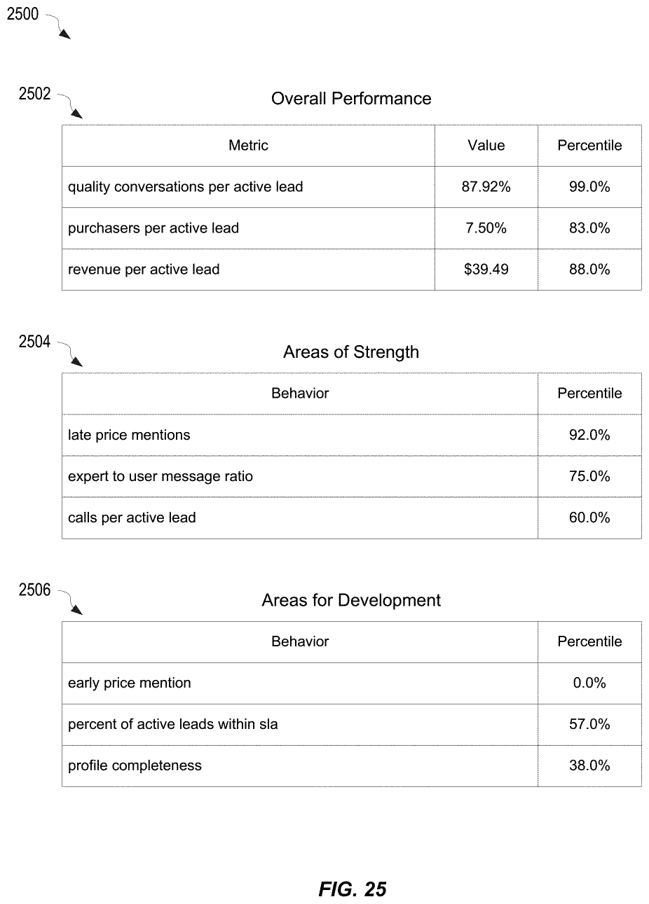

FIG. 25 shows one example performance review 2500 that may be generated at intervals (e.g., weekly) and may be sent (e.g., as an email) to advisor 102, such that advisor 102 learns which behaviors they are already doing well, and which behaviors they could improve upon to increase their performance. Performance review 2500 includes an overall performance section 2502 that summarizes at least part of performance 2430, an “areas of strength” section 2504 that summarizes strengths 2432, and an areas for development section 2506 that summarizes development 2434. Advantageously, performance review 2500 is based upon behaviors and successes of peers of advisor 102, showing percentile values that indicate how advisor 102 ranks against peers. Top behaviors in both sections 2504 and 2506 are correlated to higher conversion rates, where areas of strength section 2504 shows behaviors that advisor 102 performs more often than peers, while areas for development section 2506 show behaviors that advisor 102 performs less frequently than peers. Performance review 2500 thereby provides advisor 102 with suggestions for improving performance based upon successful behavior of peers of advisor 102.

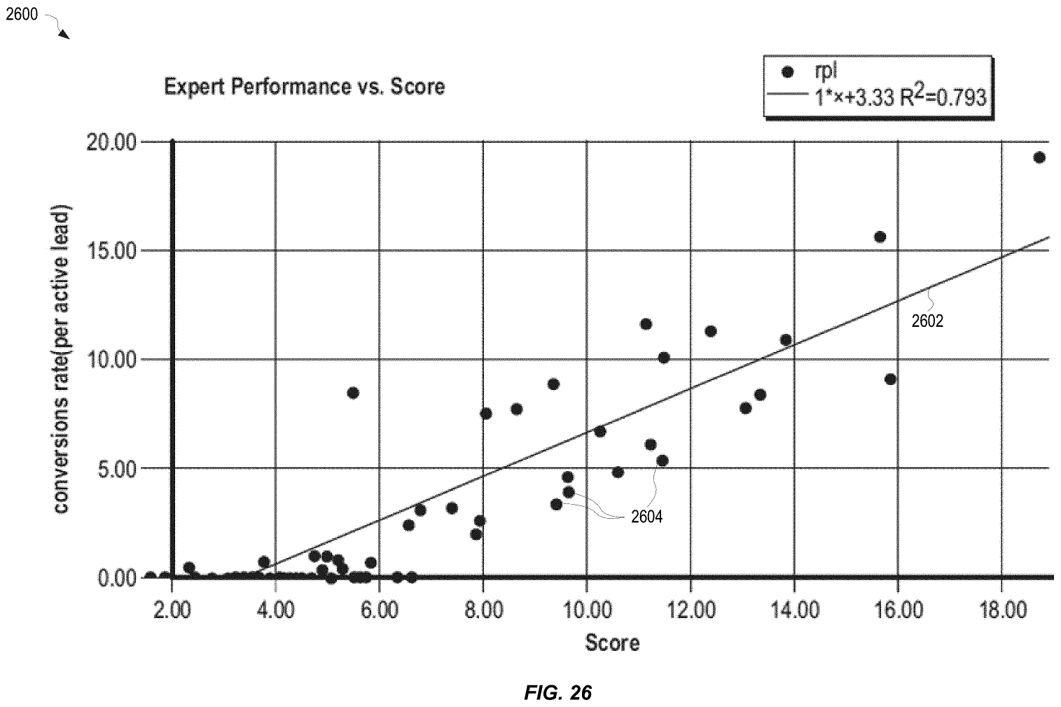

FIG. 26 is an example scatter plot 2600 showing how well MVLR model 2206 (represented by straight line 2602) fits performance 2604 (e.g., a plot of conversion rate per active lead against advisor score) for each advisor 102. As shown in FIG. 26, line 2602 approximates performance of advisors 102 based upon the advisor's score. Accuracy of MVLR model 2408 is important since MVLR model 2408 is used to evaluate advisors 102 and, in turn, to predict capacity of system 100 to handle leads 109, and thereby define spend with lead generators 108.

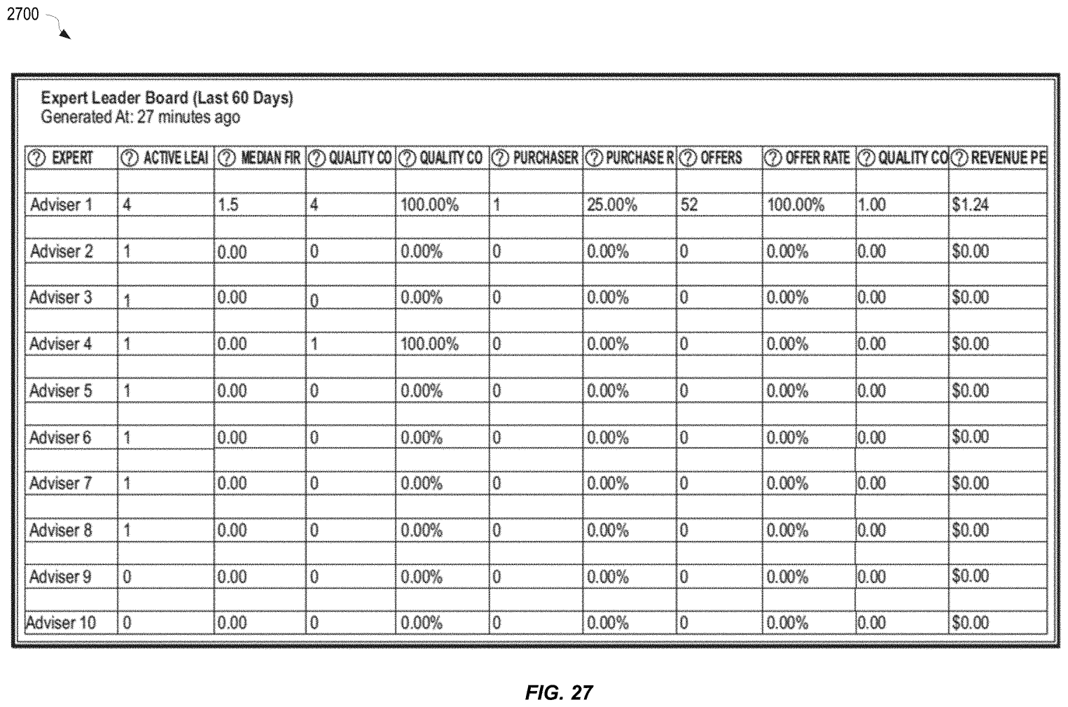

FIG. 27 shows one example leaderboard 2700, generated at intervals (e.g., hourly, daily, etc.) by system 100, showing an ordered list of the top ten performing advisors 102 over the last sixty days. For example, leaderboard 2700 may be displayed to advisor 102 via advisor application 290 as part of advisor dashboard 630 and/or via browser 294. Accordingly, each advisor 102 may see how they compare to other advisors. This may be useful to advisors who want to reach out to better performing advisors to learn tips and tricks for improvement.

### Fraud Protection Using Dynamic Statement Descriptors

Credit card fraud is the largest type of Identity theft fraud and is therefore a big problem in the payment industry. For example, worldwide in 2018, $24.6 billion was lost to payment card fraud. The United States is the country most prone to credit fraud with 38.6% of reported card fraud losses in 2018 and with more than 167,000 people reporting that a credit card was fraudulently opened in their name. This high fraud rate has an impact on e-commerce based companies that process payments. For example, an increase in chargebacks and frauds reported using a particular company name may result in that company being listed as a High-Risk Merchant, which may impact processing legitimate transactions and may impact the company receiving payouts from Payment Processors.

Given the economic impact of such fraud, it is in the interest of an online e-commerce company to make a best effort to prevent fraud. The credit card processing industry recommends several best practices to prevent fraud; using basic verification such as a corresponding zip code, and/or a card verification value (CVV), and/or using a more modern approach with 3D secure (three-domain structure) cards that implement a third-party verification step (e.g., a onetime PIN). Unfortunately, 3D secure is not mandatory and many payment cards still rely only upon the Zip code and/or the CVV to prevent fraud. Unfortunately, credit card identity theft typically results in stolen zip code, CCV and/or other information.

Dynamic statement descriptors may provide another level of defense against fraudulent use of stolen credit card information on an e-commerce site, and does not require the payment card or client be enrolled in a third-party scheme (e.g., 3D secure). A statement descriptor is included for each transaction made using a payment card and appears on the account statement (e.g., a credit card statement, a bank statement, etc.). To allow the client to recognize the transaction on their statement, most e-commerce sites use some form of static name, product name, and/or title of service rendered, as the statement descriptor. However, the statement descriptor is not limited to a static value. Advantageously, the statement descriptor may be used dynamically as a second level of fraud protection.

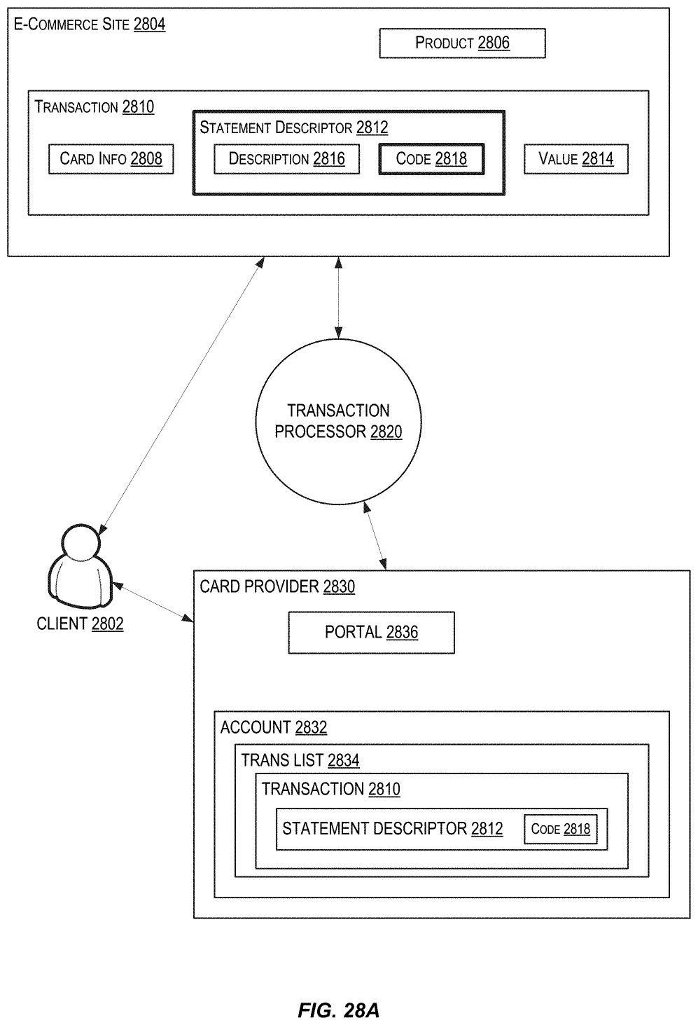

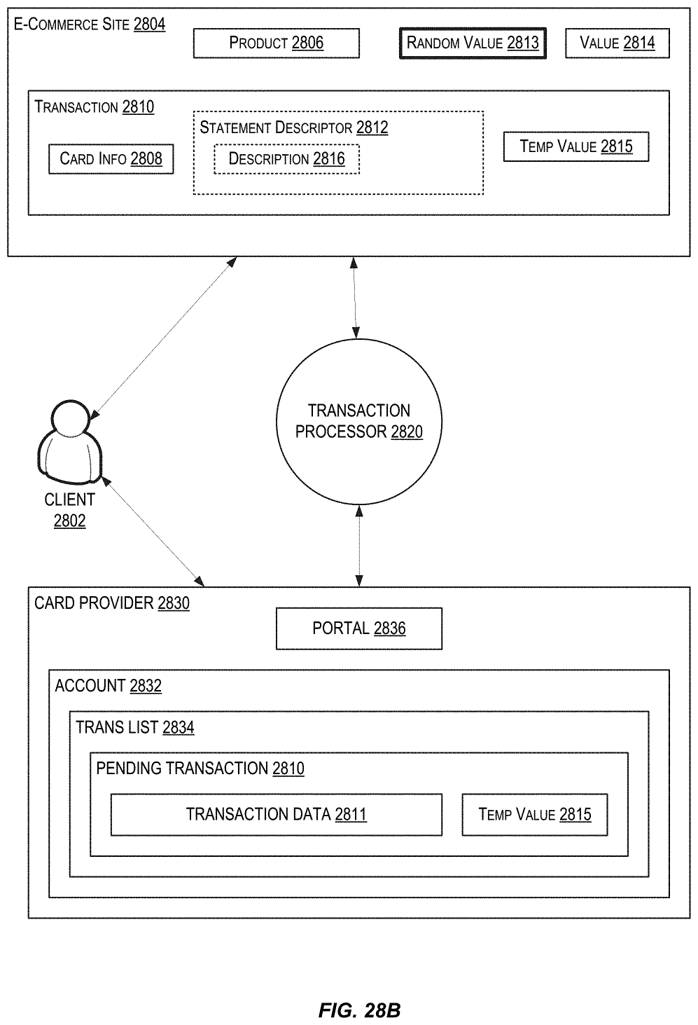

FIG. 28A is a schematic illustrating dynamic statement descriptor fraud prevention. In this example, a client 2802 interacts with an e-commerce site 2804 (e-commerce module 216 of advisor interface system 100, FIGS. 1 and 2, to purchase a product 2806. E-commerce site 2804 is implemented on a computer based server accessible via the Internet, for example. After selecting product 2806, client 2802 provides card information 2808 to e-commerce site 2804 to make the purchase, and e-commerce site 2804 creates a transaction 2810, based upon card information 2808 and that includes a statement descriptor 2812 and a value 2814 corresponding to product 2806.

E-commerce site 2804 generates a random code 2818 (e.g., six alphanumeric characters) that is included in statement descriptor 2812 together with a description 2816 of product 2806 and/or e-commerce site 2804 (e.g., a company name, trading name, web name, etc.). Statement descriptor 2812 is for example a string of characters formed by description 2816 and code 2818. E-commerce site 2804 submits transaction 2810 to a transaction processor 2820 (e.g., an entity that handles card transactions), which in turn interacts with a card provider 2830 corresponding to card information 2808. Transcription processor 2820 and card provider 2830 represent financial entities that network to support financial transactions for credit card services, banking, and so on. Accordingly, transaction 2810 is added to an account 2832 corresponding to card information 2808. However, transaction 2810 is not captured (e.g., the transaction is not completed/confirmed/finalized) and therefore transaction 2810 appears as pending in a transaction list 2834 of account 2832 and does not result in a debit of funds from account 2832. Within transaction list 2834, statement descriptor 2810 of transaction 2810 include code 2818. As a secondary fraud prevention check, e-commerce site 2804 requires client 2802 to retrieve code 2818 from statement descriptor 2812 within transaction list 2634 stored by card provider 2830, and provide the obtained code to e-commerce site 2804. For example, client 2802 may interact (e.g., using an app running on a smartphone, or using a web browser) with a portal 2836 of card provider 2830, logging in to account 2832, to retrieve code 2818. In another example, client 2802 may call card provider 2830 to retrieve code 2818 from statement descriptor 2812.

E-commerce site 2804 compares the code provided by client 2802 to code 2818 (e.g., stored in a database in association with transaction 2810), and when they match, transaction 2810 is approved and captured (e.g., through interaction with transaction processor 2820) and funds corresponding to value 2814 are debited from account 2832. Where the returned code does not match code 2818, or no code is returned within a defined period (e.g., ten minutes, one hour, one day, and so on), the payment process is failed and transaction 2810 is cancelled.

Advantageously, through use of code 2818 within statement descriptor 2812, e-commerce site 2804 may gain confidence that client 2802 is in rightful control of card information 2808 provided for transaction 2810, since client 2802 also has access to corresponding account 2832. Particularly, no additional parties are required to provide this additional validation of client 2802, and without access to account 2832, no adverse party can fraudulently use card information 2808.

Certain card providers 2830 (e.g., American Express) may not display statement descriptor 2812 for pending transactions within account 2832, and thus, client 2802 cannot respond to e-commerce site 2804 and provide code 2818. Card provider 2830 may provide certain transaction data 2811 (e.g., transaction date and time), that may allow client 2802 to distinguish between other transactions within transaction list 2834. FIG. 28B is a schematic illustrating alternative dynamic fraud prevention. In this embodiment, where e-commerce site 2804 determines that card provider 2830 does not display statement description 2812, e-commerce site 2804 generates a random value 2813 between 0.01 and 1.00 (to two decimal places), and adds random value 2813 to value 2814 to forms a temporary value 2815 within transaction 2810. Neither random value 2813 nor temporary value 2815 is displayed by e-commerce site 2804 to client 2802, but is included with pending transaction 2810 in transaction list 2834 of account 2832. Accordingly, temporarily value 2815 may be retrieve only by client 2802 accessing account 2832.

E-commerce site 2804 requires client 2802 to retrieve temporary value 2815 from transaction 2810 within transaction list 2634 by interacting with card provider 2830, as described above, and to provide at least the decimal portion of temporary value 2815 to e-commerce site 2804. E-commerce site 2804 compares the provided decimal value with the temporary value 2815, and when they match (e.g., when client 2802 provides at least the correct decimal portion of temporary value 2815, temporary value 2814 is replaced by the actual value 2814 within transaction 2810, and transaction 2810 is approved and captured (e.g., through interaction with transaction processor 2820) and funds corresponding to value 2814 are debited from account 2832. Where the returned value does not match temporary value 2815, or no code is returned within a defined period (e.g., ten minutes, one hour, one day, and so on), the payment process is failed and transaction 2810 is cancelled.

Advantageously, through use of random value 2813 and corresponding temporary value 2815 of transaction 2810, e-commerce site 2804 may gain confidence that client 2802 is in rightful control of card information 2808 provided for transaction 2810, since client 2802 also has access to corresponding account 2832. Again, no additional parties are required to provide this additional validation of client 2802, and without access to account 2832, no adverse party can fraudulently use card information 2808.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween. In particular, the following embodiments are specifically contemplated, as well as any combinations of such embodiments that are compatible with one another:

(A) A method for managing interaction between one advisor of a plurality of advisors and a client, including: determining client intent based upon request details that indicate a category of interest to the client; selecting the one advisor from the plurality of advisors to advise the client based, at least in part, upon the category of interest and the client intent; adding the client to a sales pipeline of the one advisor; prompting, at intervals, the one advisor to interact with the client; prompting the one advisor to generate a curation for the client; and sending the curation to the client.

(B) The method denoted as (A), further including receiving, in response to the curation, an agreement from the client.

(C) Either of the methods denoted as (A) or (B), further including interactively capturing the request details from the client prior to the step of determining the client intent.

(D) In any of the methods denoted as (A)-(C), the interactively capturing including: receiving a new lead from a lead source, the new lead defining the category of interest and including contact information of the client; selecting a path schema based, at least in part, upon the category of interest; generating a path flow based upon the path schema; sending, using the contact information, a link to a web site implementing the path flow to the client; and capturing the request details based upon interaction of the client with the path flow.

(E) In any of the methods denoted as (A)-(D), the step of selecting the one advisor further including: determining a workload of each of the plurality of advisors; determining client characteristics based upon the interaction of the client with the path flow; determining a ranking of each of the plurality of advisors based, at least in part, upon one or more of the category of interest, the client intent, and the client characteristics; and selecting the one advisor with the highest ranking.

(F) In any of the methods denoted as (A)-(E), the prompting the one advisor to interact with the client including: determining, based upon prior interaction of the one advisor with the client stored within the sales pipeline, a next suggested action for the one advisor in association with the client; and indicating, to the one advisor within a display of the sales pipeline, the next suggested action for the client.

(G) Any of the methods denoted as (A)-(F), further including: ordering the sales pipeline based upon an urgency of the next suggested action; and displaying the ordered sales pipeline to the one advisor to indicate the next suggested action for the client.

(H) In any of the methods denoted as (A)-(G), the prompting the one advisor to generate the curation including: determining, based, at least in part, upon the sales pipeline, a curation time indicative of when the client is likely to accept the curation; adding, at the curation time, a next suggested action for the one advisor in association with the client; and indicating, to the one advisor within a display of the sales pipeline, the next suggested action for the client.

(I) In any of the methods denoted as (A)-(H), the curation including a personalized recommendation of at least one product based upon the category of interest, the client intent, and a conversation between the client and the one advisor stored in the sale pipeline.

(J) Any of the methods denoted as (A)-(I), further including: for each of a plurality of categories handled by the method: for each of the plurality of advisors: determining an expected new lead capacity for an upcoming period, based, at least in part, upon a current workload of the one advisor and a schedule of the one advisor for the upcoming period; and determining a max lead cap for the one advisor based, at least in part, upon one or both of the current workload of the one advisor, and a ranking of the one advisor; determining, for the upcoming period, a total new lead capacity for the category by summing a new lead capacity for each of the plurality of advisors; determining, for the upcoming period, a new lead spend amount for the category based, at least in part, upon the total new lead capacity and characteristics of at least one lead generator.

(K) In any of the methods denoted as (A)-(J), the upcoming period is one day.

(L) In any of the methods denoted as (A)-(K), further including: determining an unassigned lead count of new leads not yet assigned to any of the plurality of advisors; and setting the new lead spend amount to zero when the unassigned lead count is greater than the total new lead capacity.

(M) Any of the methods denoted as (A)-(L), further including: determining an event; processing at least one trigger sequence against the event, the at least one trigger sequence evaluating one or more conditions and defining at least one action when the conditions are met; and implementing the action.

(N) In any of the methods denoted as (A)-(M), the at least one action being selected from the group consisting of: sending a notification to the one advisor, sending a notification to an operator, generating a next suggested action for the one advisor.

(O) In any of the methods denoted as (A)-(N), the step of selecting the one advisor including: determining, for each of the plurality of advisors, an advisor score based, at last in part, upon one or more of the category of interest, a ranking of the advisor, a workload of the advisor, and characteristics of the client; and selecting the advisor having the highest score.

(P) A path module, including: a path builder having machine readable instructions stored in memory that, when executed by at least one processor, cause the processor to implement an interface for creating and editing sets of question types and answer types to form a path schema; a selection algorithm having machine readable instructions stored in the memory that, when executed by the processor, cause the at least one processor to generate a path flow based, at least in part, upon the path schema, the path flow comprising at least one web page with a set of questions for receiving request details from a client; wherein the request details include at least one answer to one or more of the set of questions.

(R) In the path module denoted as (P), the path flow being generated in response to the client visiting a web site and based upon client characteristics.

(S) A client trust interface method with optimized workflow, including: specifying a spend on leads to identify a plurality of clients; capturing intent of one client of the plurality of clients; matching one advisor of a plurality of advisors to the one client; triggering actions of the one advisor to correspond with the one client; and generating a curation based at least in part upon request details of the one client.

(T) The client trust interface method denoted as (S), further including determining the spend based at least in part upon a workload capacity of each of the plurality of advisors and a current workload of each of the plurality of advisors.

(U) Either of the client trust interface methods denoted as (S) or (T), further including switching from a first communication channel to a second communication channel when the one client goes offline.

(V) A client trust interface system, including: a workload optimizer for determining a current workload of each of a plurality of advisors and for determining a workload capacity of each of the plurality of advisors, the workload optimizer defining a spend for generating new leads based upon the current workload and the workload capacity of each of the plurality of advisors; a client interface for interacting with each of a plurality of clients to determine intent of each of the plurality of clients; an advisor matcher for matching one advisor of the plurality of advisors with one client of the plurality of clients based upon the intent of the one client and a capability of the one advisor; a trigger algorithm for prompting a next action for the one advisor based upon a history of actions by the one advisor and responses by the one client; and a communication channel controller (path) for switching between communication channels to maintain communication between the one client and the one advisor.

(W) An e-commerce method for card fraud protection, including: determining, at an e-commerce site, a value to be charged to a card of a client; generating a random code; including the random code in a transaction for the card; sending the transaction to a card provider corresponding to the card, wherein the transaction is posted as pending in a transaction list of an account corresponding to the card; receiving, from the client, a code value determined from display of the transaction; and finalizing the transaction with the card provider for the value to be charged when the code value matches the random code.

(X) The e-commerce method denoted as (W), further including: determining, based upon an entity associated with the card, whether statement descriptors of pending transactions are displayed in the transaction list; when statement descriptors of pending transactions are displayed: generating the random code as a string of visible characters; and including the string of visible characters in a statement descriptor of the transaction; when statement descriptors are not displayed: generating the random code as a random value between 0.01 and 1.00; and adding the random value to the value to be charged to form a temporary value that is included within the transaction in place of the value to be charged; and requesting the client provide a pending transaction value of the transaction as the code value, wherein the code value is matched to the temporary value.

What is claimed is:

1. An e-commerce method for card fraud protection, comprising:
receiving, at an e-commerce site, card information from a client interacting with the e-commerce site;
generating a transaction based on the card information and including a random code;
sending the transaction to a card provider corresponding to the card information, wherein the transaction and random code are posted as a pending transaction in a transaction list of an account corresponding to the card;
receiving, from the client, a code value retrieved from the card provider; and
finalizing the transaction with the card provider when the code value matches the random code.

2. The e-commerce method of claim 1, wherein the random code is not displayed by the e-commerce site.

3. The e-commerce method of claim 1, wherein the random code is a string of visible characters, the method further comprising storing the random code in a statement descriptor of the transaction.

4. The e-commerce method of claim 3, the statement descriptor being displayed in the transaction list.

5. The e-commerce method of claim 1, wherein access to the transaction list by the client requires logging in to the account.

6. The e-commerce method of claim 1, wherein access to the transaction list requires the client to call the card provider to retrieve the pending transaction and the random code.

7. The e-commerce method of claim 1, wherein the transaction is a conventional card transaction that requires no special handling or action by the card provider.

8. The e-commerce method of claim 1, further comprising cancelling the transaction when the code value does not match the random code.

9. The e-commerce method of claim 1, further comprising cancelling the transaction when the code value is not received within a predefined period.

10. An e-commerce method for card fraud protection, comprising:
receiving, at an e-commerce site, card information from a client interacting with the e-commerce site for payment of a value;
generating a random value between 0.01 and 1.00;
adding the random value to the value to form a temporary value;
generating a transaction for the temporary value based on the card information;
sending the transaction to a card provider corresponding to the card information, wherein the transaction is posted as a pending transaction in a transaction list of an account corresponding to the card;
receiving, from the client, a pending transaction value of the pending transaction; and
finalizing the transaction for the value with the card provider when the pending transaction value matches the temporary value.

11. The e-commerce method of claim 10, further comprising requesting, on the e-commerce site, the client retrieves the pending transaction value of the transaction from the transaction list.

12. The e-commerce method of claim 10, wherein neither the random value nor the temporary value are displayed by the e-commerce site.

13. The e-commerce method of claim 10, wherein access to the transaction list requires logging in to the account.

14. The e-commerce method of claim 10, wherein access to the transaction list requires the client to call the card provider to retrieve the pending transaction value.

15. The e-commerce method of claim 10, wherein the transaction is a conventional card transaction that requires no special handling or action by the card provider.

16. The e-commerce method of claim 10, further comprising cancelling the transaction when the pending transaction value does not match the temporary value.

17. The e-commerce method of claim 10, further comprising cancelling the transaction when the pending transaction value is not received within a predefined period.
